(19) United States
(12) Patent Application Publication
(10) Pub. No.: US 2020/0371673 A1
(43) Pub. Date: Nov. 26, 2020

(54) ADAPTIVE INTERACTION MODELS BASED ON EYE GAZE GESTURES

(71) Applicant: MICROSOFT TECHNOLOGY LICENSING, LLC, Redmond, WA (US)

(72) Inventor: Jason Thomas FAULKNER, Seattle, WA (US)

(21) Appl. No.: 16/420,125

(22) Filed: May 22, 2019

(51) Int. Cl. G06F 3/0484; G06F 3/01; G06F 3/0481; G06F 3/16

(52) U.S. Cl. CPC G06F 3/04845; G06F 3/013; G06F 2203/04806; G06F 3/04815; G06F 3/167; G06F 3/04842

(57) ABSTRACT

The techniques disclosed herein provide improvements over existing systems by allowing users to efficiently modify an arrangement of a user interface of a communication session by the use of an eye gaze gesture. An eye gaze gesture input can be utilized to focus on particular aspects of shared content. In addition, an eye gaze gesture can be utilized to configure an arrangement of a user interface displaying multiple streams of shared content of a communication session. A focused view of shared content and customized user interface layouts can be shared with specific individuals based on roles and or permissions. In addition, the disclosed techniques can also select and display unique user interface controls based on an eye gaze gesture. In one illustrative example, a specific set of functionality can be made available to a user based on a type of an object that is selected using an eye gaze gesture.

### BACKGROUND

There are a number of different systems and applications that allow users to collaborate. For example, some systems provide collaborative environments that allow participants to exchange files, live video, live audio, and other forms of content within a communication session. In other examples, some systems allow users to post messages to a channel having access permissions for a select group of individuals for the purposes of enabling team-focused or subject-focused conversations.

Although there are a number of different types of systems and applications that allow users to collaborate and share content, users may not always benefit from a particular exchange of information or a meeting using these systems. For example, if a system does not display an optimized arrangement of shared content, users may not be able to readily identify the salient aspects of the shared content. In some scenarios, if shared content is not displayed properly, users may miss important details altogether. This problem may occur when graphs or charts are not properly sized to show all of the relevant details. This problem may also occur when detailed drawings or renderings of three-dimensional objects are shared at a fixed zoom level.

The issues described above may not only cause users to miss important content; such issues can also impact user engagement. The optimization of user engagement for any software application is essential for user productivity and efficient use of computing resources. When software applications do not optimize user engagement, production loss and inefficiencies with respect to computing resources can be exacerbated when a system is used to provide a collaborative environment for a large number of participants. For example, the layouts of some graphical user interfaces (UIs) do not always display shared content in a manner that is easy to read or pleasing to the user. Some systems often display video streams and images without properly aligning or scaling the content, and some systems do not always display the right content at the right time. Such systems work against the general principle that proper timing and graphical alignment of content are essential for the optimization of user engagement and efficient use of computing resources.

Some existing systems provide tools for allowing users to manually modify a user interaction model of an application. For instance, some programs allow users to modify a user interface layout and also change audio settings to accommodate specific user needs. However, such systems require users to perform a number of menu-driven tasks to arrange graphical user interfaces, select content, and change audio and video settings. A user can spend a considerable amount of time searching through available items to select the content that is relevant to a particular purpose. Such systems then require users to manually generate a desired layout of selected graphical items. This can lead to extensive and unnecessary consumption of computing resources.

It is with respect to these and other technical challenges that the disclosure made herein is presented.

### SUMMARY

The techniques disclosed herein provide improvements over existing systems by enabling users to efficiently customize interaction models of an application based on eye gaze gestures. A system can create a custom interaction model by adapting an arrangement of a user interface and specify focused areas of content displayed within the user interface by the use of an eye gaze gesture. A system can also create a custom interaction model by activating contextually-relevant interaction controls that are based on a type of object that is selected using an eye gaze gesture. A user interface that is customized using eye gaze gestures and contextually-relevant interaction controls can also be shared with specific individuals based on roles and permissions of each individual.

In one illustrative example, a user's gaze gesture can be utilized by a system to configure an arrangement and level of focus of content shared within a communication session. A user can cause a system to rearrange or pin objects displayed on a user interface by selecting each object with a gaze gesture. A user can also cause a system to change a level of focus of a particular object based on a gaze gesture. A supplemental user input, such as a hand gesture and a voice command, can be utilized in conjunction with the gaze gesture to generate a focused view of shared content and customize user interface arrangement. The customized user interface can be shared with specific participants of the communication session based on roles and or permissions.

In another example, a system can select and display unique user interface controls based on a gaze gesture. In one illustrative example, a system can analyze a type of object that a user has selected using a gaze gesture. Based on the object type, the system can select a specific set of functions that are made to be available to a user. In some configurations, the set of functions can be made available to a user by displaying customized user interface elements. The user interface elements can receive a selection of a specific function and cause a computing device to perform the selected function. The customized user interface elements can also display the determined object type. User interactions with the computing device can be improved by allowing the system to reduce the number of functions that are made available to a user. By narrowing the number of functions that are made available, the user interface can be simplified by only displaying contextually relevant menu options based on an object type or a state of available functions.

The features disclosed herein allow computing devices to efficiently utilize screen space by mitigating the need to display a large number of menu options. By dynamically showing contextually relevant menu options, a computing device can allow the display of more content instead of consuming user interface space with a wide range of menu options. In addition, the features disclosed herein also readily notify users of an object type they are viewing, as some displays of data may not readily allow users to identify an object type from a rendering of the object. A notification of an object type can allow users to interact with the object more accurately since they are readily informed of the object type. For instance, in some situations, a user may not be able to readily determine if an object they are viewing is a virtual object or an image of a real-world object. In such a scenario, a user may inadvertently provide an input that is specific for a virtual object when they are actually looking at a real-world object, and vice versa. A system providing a notification of an object type can help mitigate such inefficiencies.

The examples described herein are provided within the context of collaborative environments, e.g., private chat sessions, multi-user editing sessions, group meetings, live broadcasts, etc. For illustrative purposes, it can be appreciated that a computer managing a collaborative environment involves any type of computer managing a communication session where two or more computers are sharing data. In addition, it can be appreciated that the techniques disclosed herein can apply to any user interface arrangement that is used for displaying content. The scope of the present disclosure is not limited to embodiments associated with collaborative environments.

The techniques disclosed herein provide a number of features that improve existing computers. For instance, computing resources such as processor cycles, memory, network bandwidth, and power, are used more efficiently as a system can transition between different interaction models with minimal user input. By providing customized user interfaces that focus on objects of interest, the techniques disclosed herein can provide more efficient use of computing resources by mitigating the display of lower priority content. By the use of eye gaze gestures (also referred to herein as “gaze gestures”), the system can improve user interaction with the computing device by mitigating the need for other input devices such as keyboards and pointing devices. Improvement of user interactions can lead to the reduction of unnecessary user input actions, which can mitigate inadvertent inputs, redundant inputs, and other types of user interactions that utilize computing resources. Other technical benefits not specifically mentioned herein can also be realized through implementations of the disclosed subject matter.

Those skilled in the art will also appreciate that aspects of the subject matter described herein can be practiced on or in conjunction with other computer system configurations beyond those specifically described herein, including multiprocessor systems, microprocessor-based or programmable consumer electronics, augmented reality or virtual reality devices, video game devices, handheld computers, smartphones, smart televisions, self-driving vehicles, smart watches, e-readers, tablet computing devices, special-purpose hardware devices, networked appliances, and the others.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates a system that enables users to efficiently customize interaction models of an application based on a gaze gesture.

FIG. 2A illustrates an example scenario for providing focus to shared content that is selected by a gaze gesture.

FIG. 2B illustrates an example scenario where a participant performs a gaze gesture that indicates a gaze target on a user interface.

FIG. 2C illustrates an example scenario for causing the user interface to transition to a layout that brings focus to a selected target in response to a gaze gesture selecting a particular object.

FIG. 2D illustrates an example scenario for continuing the user interface transition that brings focus to a selected target in response to a gaze gesture selecting a particular object.

FIG. 2E illustrates a resulting layout of a user interface that focuses on a target selected by a gaze gesture.

FIG. 3A illustrates an example scenario of a participant performing a gaze gesture that indicates a gaze target.

FIG. 3B illustrates an example scenario of the user interface transitioning the layout to focus on the selected object in response to the object selection by the gaze gesture.

FIG. 3C illustrates the resulting layout of the user interface that is reconfigured using a gaze gesture.

FIG. 4A illustrates an example scenario showing the first stage of a process for reconfiguring the display of an object using a gaze gesture.

FIG. 4B illustrates an example scenario of a participant performing a gaze gesture that indicates a gaze target on a user interface displaying a time indicator.

FIG. 4C illustrates an example scenario for displaying an interaction control of options for the user to select.

FIG. 4D illustrates an example scenario involving a user interface where a user selects a function of the interaction control having contextually relevant options.

FIG. 4E illustrates an example scenario for the system to determine a gaze target for an additional object to be selected.

FIG. 4F illustrates an example scenario, subsequent to an elapsed time period, in which the system can display an interaction control having contextually relevant options.

FIG. 4G illustrates an example scenario involving a user interface where a user selects a function of the interaction control having contextually relevant options.

FIG. 4H illustrates an example scenario involving a user interface where a user selects a function of the interaction control having a function to complete a reconfiguration process.

FIG. 4I illustrates an example scenario in which the system controls display properties of the selected objects to keep them maintained in fixed location and size within a user interface.

FIG. 4J illustrates an example scenario in which the system controls display properties of the selected objects to keep them maintained in fixed location and size within a user interface while the system receives data to change the display of other display areas.

FIG. 4K illustrates an example scenario of a user interface displaying a supplemental interaction control enabling the system to share a reconfigured user interface with other users.

FIG. 4L illustrates an example scenario for a system to receive control data defining the reconfigured user interface and distribute the control data to select devices.

FIG. 5A illustrates an example scenario where the user performs a gaze gesture that positions a gaze target over a virtual object.

FIG. 5B illustrates an example scenario wherein the selection of a virtual object by a user causes the system to select a set of functions based on the object type.

FIG. 5C illustrates an example scenario wherein the computing device receiving the input of the user selection of a particular function provides control data to a server which can distribute metadata or permission data to other devices to perform the selected function or utilize the permission data.

FIG. 5D illustrates an example scenario where the user performs a gaze gesture that positions a gaze target over a virtual object that is displayed within a content object.

FIG. 5E illustrates an example user interface that can be displayed when a gaze gesture is used to select a virtual object that is displayed within a content object.

FIG. 6A illustrates an example scenario where the user performs a gaze gesture that positions a gaze target over a physical object.

FIG. 6B illustrates an example scenario wherein the selection of a physical object by a user causes the system to select a set of functions based on the object type.

FIG. 6C illustrates an example scenario wherein the computing device receiving the input of the user selection of a particular function provides control data to a server which can distribute metadata or permission data to other devices to perform the selected function or utilize the permission data.

FIG. 7A illustrates an example scenario where the user performs a gaze gesture that positions a gaze target over a content object.

FIG. 7B illustrates an example scenario wherein the selection of a content object by a user causes the system to select a set of functions based on the object type.

FIG. 7C illustrates an example scenario wherein the computing device receiving the input of the user selection of a particular function provides control data to a server which can distribute metadata or permission data to other devices to perform the selected function or utilize the permission data.

FIG. 7D illustrates an example user interface wherein the system causes the display of a graphical element in response to a particular object being selected, which object is pinned within the user interface.

FIG. 7E illustrates an example user interface wherein the pinned object remains fixed with respect to its size and location, while other unpinned objects in the user interface are freed to be moved or resized based on a level of activity associated with each object.

FIG. 8A illustrates an example user interface where the user has selected a virtual object by the use of a gaze gesture.

FIG. 8B illustrates an example user interface where the user provides a supplemental input, particularly focused gesture input, to control the size of a crop region of a particular pinned object.

FIG. 8C illustrates an example user interface where the user selects a pin focus function with respect to the selected object.

FIG. 8D illustrates an example user interface where the user has selected a physical object by the use of a gaze gesture.

FIG. 8E illustrates an example user interface where the user selects a crop region for the selected object by selecting an option of an interaction control.

FIG. 8F illustrates an example reconfigured user interface that is generated based on execution of the selected functions.

FIG. 9A illustrates an example user interface where a gaze gesture is utilized to determine a gaze target for purposes of selecting an object.

FIG. 9B illustrates a user providing a supplemental input to the user interface to indicate a direction.

FIG. 9C illustrates an example user interface that is generated based on selection of the object, the rendering of the third user, and the supplemental gesture indicating a right bias.

FIG. 9D illustrates an example user interface that is generated based on selection of the object, the rendering of the third user, and the supplemental gesture indicating a left bias.

FIG. 10 is a flow diagram illustrating aspects of a routine for computationally efficient selection and modification of rendered objects using a gaze gesture.

FIG. 11 is a computing system diagram showing aspects of an illustrative operating environment for the technologies disclosed herein.

FIG. 12 is a computing architecture diagram showing aspects of the configuration and operation of a computing device that can implement aspects of the technologies disclosed herein.

FIG. 13 is a computing device diagram showing aspects of the configuration and operation of a mixed reality device that can implement aspects of the disclosed technologies, according to one embodiment disclosed herein.

### DETAILED DESCRIPTION

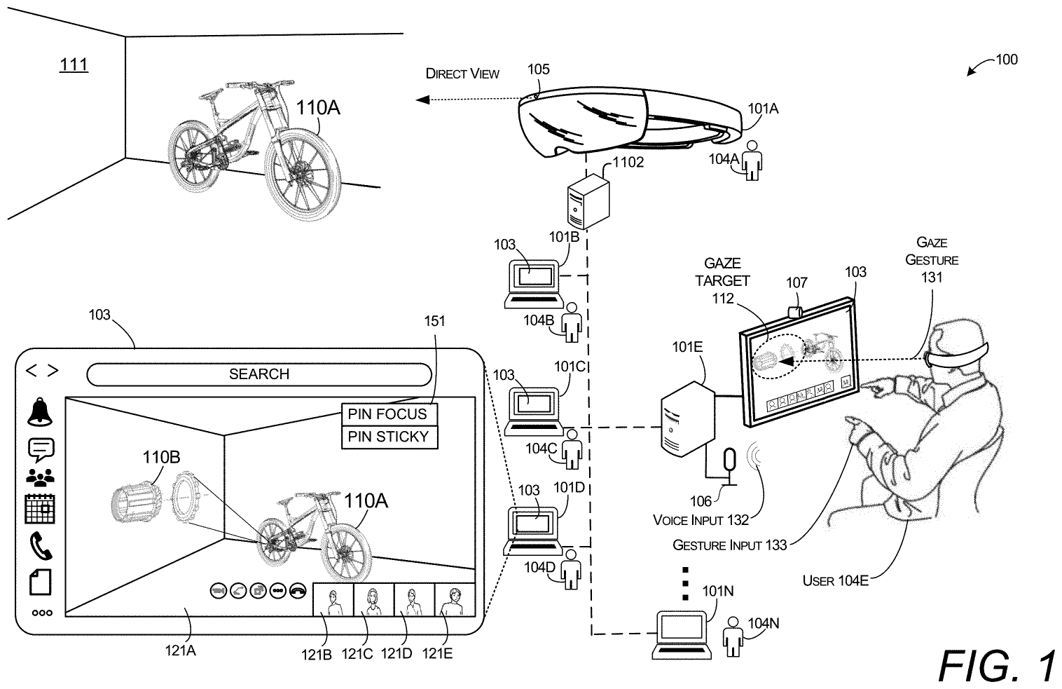

FIG. 1 illustrates a system 100 that enables users 104 to efficiently customize interaction models of an application based on a gaze gesture 131. In some configurations, a system 100 can adapt an arrangement of objects rendered within a user interface 103 and specify a focus area of a rendered object by the use of a gaze gesture 131. As will be described in more detail below, a user interface 103 that is customized by the use of a gaze gesture 131 can be shared with specific individuals based on roles and permissions of each individual. The system 100 can also activate contextually-relevant interaction controls 151 that are selected based on a type of object that is selected by a gaze gesture 131 or other factors. The interaction controls 151 can be used to provide functionality to modify, share, display, or otherwise process shared content.

A user can supplement the gaze gesture 131 with other types of input including, but not limited to a voice input 132 captured by a microphone 106, a gesture input 133 captured by a sensor 107, a touch gesture captured by a display device, a pointing device, a digital inking device, etc. The sensor 107 can also be used to capture a user's gaze gesture 131 to determine a gaze target 112. The sensor 107 can include a depth map camera, an imaging camera, a video camera, and infrared detector, lidar device, radar device, or any other suitable mechanism for tracking the movement of the user. The gaze target 112 may be an area of a user interface 103. The system 100 can then select any object within the gaze target 112. A displayed object can include, but is not limited to, a rendering of a real-world object 110A, a rendering of a virtual object, a rendering of a video stream, a rendering of a still image, etc.

The system 100 can be configured to provide a collaborative environment that facilitates the communication between two or more computing devices. A system 100 providing a collaborative environment can allow users 104 (also referred to herein as “participants 104” of a communication session) to exchange live video, live audio, and other forms of content within a communication session. A collaborative environment can be in any suitable communication session format including but not limited to private chat sessions, multi-user editing sessions, group meetings, broadcasts, etc.

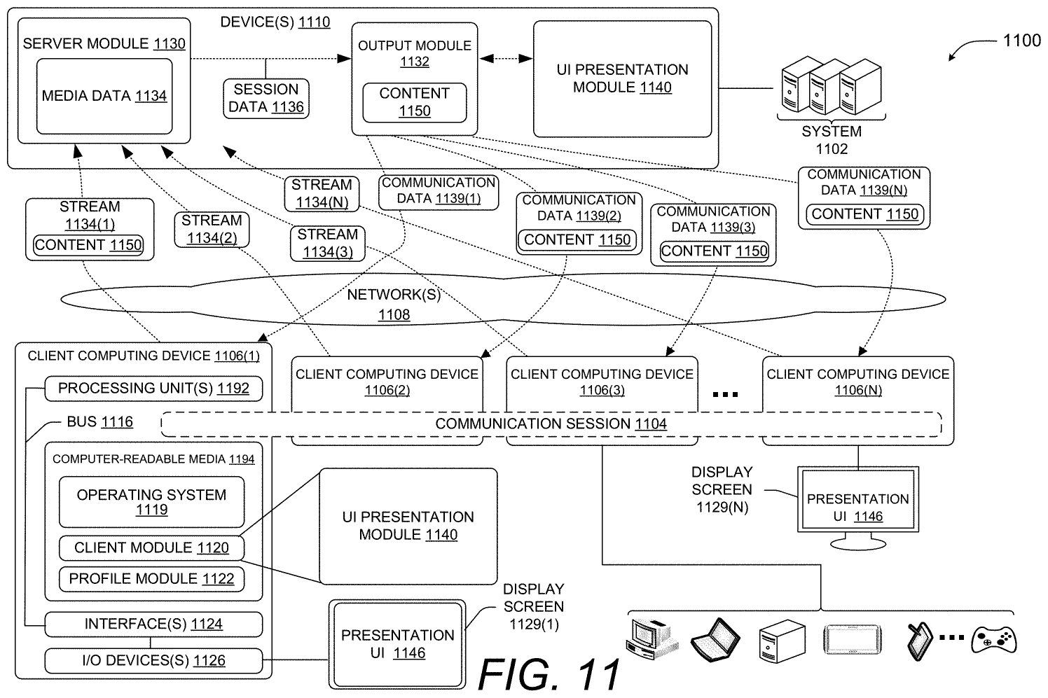

The system 100 can include a server 1102 (also shown in FIG. 11) to manage a communication session between any suitable number of computing devices 101. In this example, the system 100 facilitates a communication session between a first computing device 101A, second computing device 101B, third computing device 101C, fourth computing device 101D, fifth computing device 101E, up to any number of computing devices 101N, collectively referred to herein as “computing devices 101.” The computing devices 101 can be in any form such as a laptop, desktop, tablet, phone, a virtual reality head-mounted device, or a mixed-reality device.

In the example shown in FIG. 1, the first computing device 101A is a mixed-reality device that displays a rendering of a real-world object 110A positioned within a real-world environment 111. The real-world object 110A is also referred to herein as a “physical object 110A” and the real-world environment 111 is also referred to herein as a “physical environment 111.” The first computing device 101A can generate a stream or other data that can cause other computing devices (101B-101N) to display a rendering of the real-world object 110A concurrently with computer-generated objects 110B. For example, a computer-generated object 110B can include a three-dimensional virtual object, a two-dimensional image, a video, an icon, a data file, etc. In more specific examples, a computer-generated object 110B can include different types of files, such as, but not limited to, a document, a spreadsheet, a presentation file, etc.

In some embodiments, the computer-generated object 110B can be superimposed over a view of the real-world environment 111 by the use of a prism that provides a user with a direct line-of-sight view of the real-world object 110A and the real-world environment 111. Thus, the user can physically see the real-world object 110A and the real-world environment 111 through the prism. The prism allows the user to see natural light reflecting from the real-world object 110A and the real-world environment 111, while also allowing the user to see light that is generated from a display device for rendering a computer-generated object 110B. By directing light from both a real-world object 110A and light from a device for rendering a computer-generated object toward a user's eyes, the prism allows a system to augment aspects of a real-world view by providing coordinated displays of computer-generated objects. Although prisms are utilized in this example, it can be appreciated that other optical devices can be utilized to generate an augmented view of the real-world environment 111. For instance, in one alternative embodiment, a mixed reality device can capture an image of the real-world object 110A and the real-world environment 111 and display that image on a display screen with the computer-generated objects that can augment the image of the real-world object 110A.

In some embodiments, the first computing device 101A utilizes an imaging device 105, such as a camera, to capture an image of the real-world object 110A and the real-world environment 111. The first computing device 101A can also include sensors for generating model data defining a three-dimensional (3D) model of the real-world object and the real-world environment 111. The model data and the image can be shared with other computing devices to generate a 3D rendering or a 2D rendering of the real-world object 110A and the real-world environment 111.

The computing devices 101 can display a user interface 103 comprising a number of different display areas 121A-121E. Content shared by video streams, audio streams, or files, can be communicated between each of the computing devices 101. Each of the computing devices 101 can display the shared content on a user interface 103. One or more computing devices 101 of the system 100 can select an interaction model that can control a layout of the display areas 121 within a user interface 103 display to users 104 at each computing device 101. The system can also dynamically determine a focus region for content that is to be displayed within a user interface 103. The system can also dynamically select functionality and also display an interface element 151 that describes or provides access to the selected functionality. For illustrative purposes, the interface element 151 is also referred to herein as an “interaction control 151,” “menu 151,” or a “notification 151.” The interaction control 151 can be a displayed interface element, a computer-generated voice instruction, or any other type of output that can communicate a description of a selected set of functions, an object type, or other instructions prompting a user to provide an input.

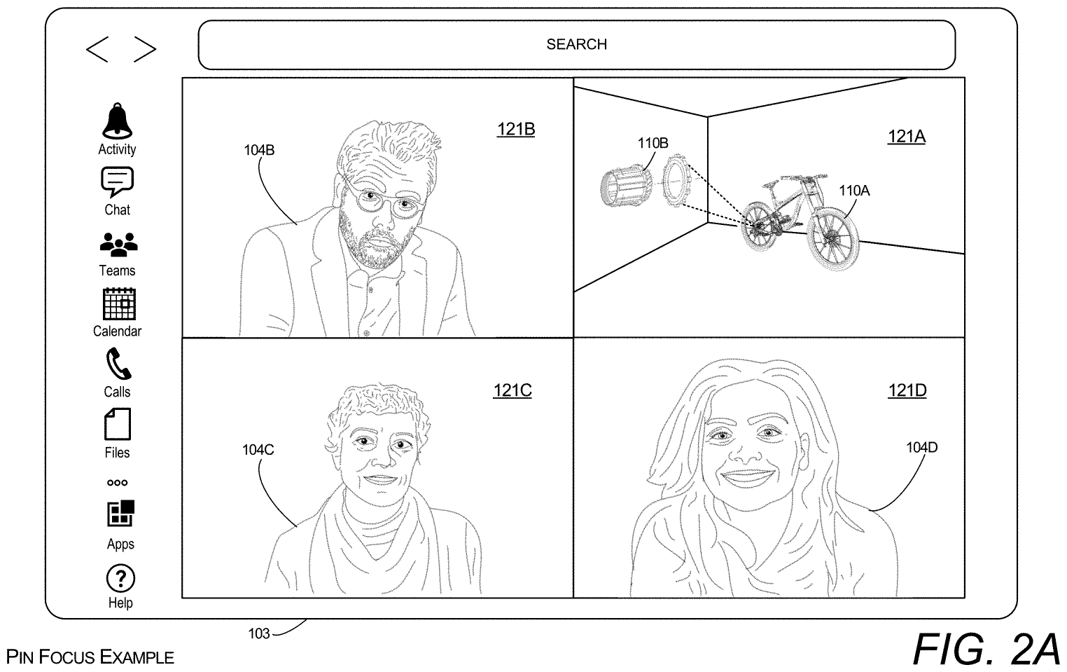

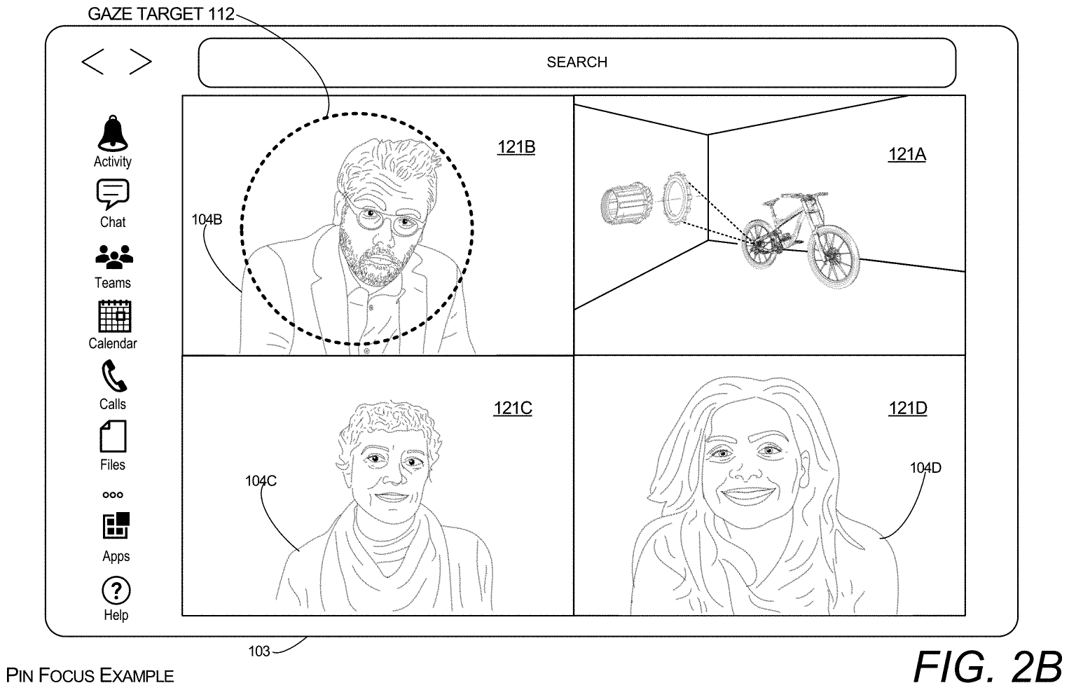

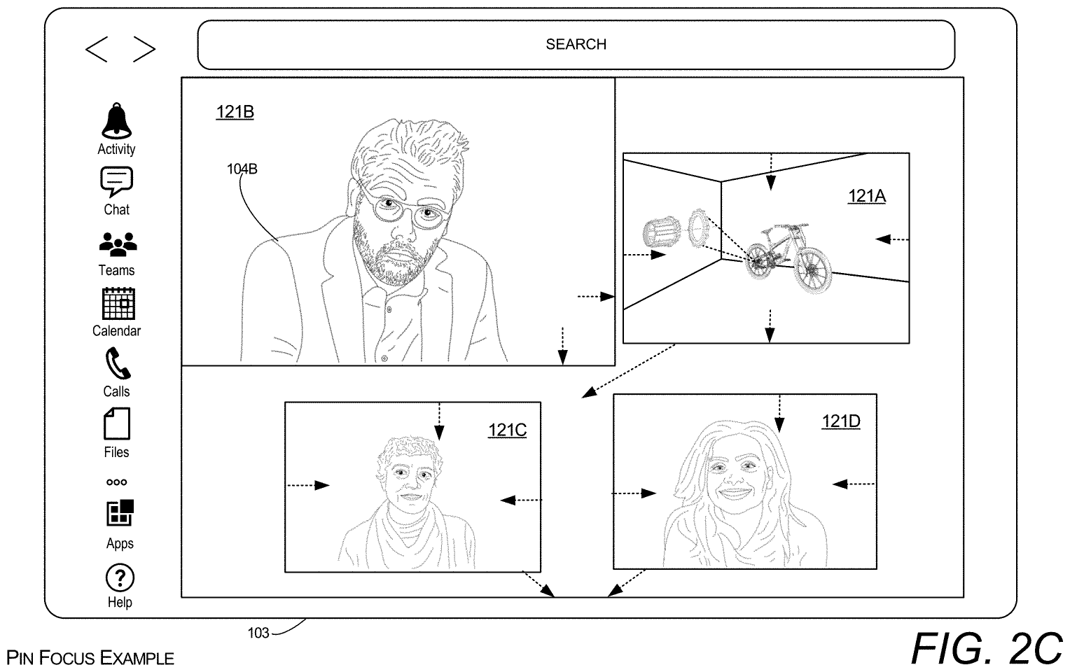

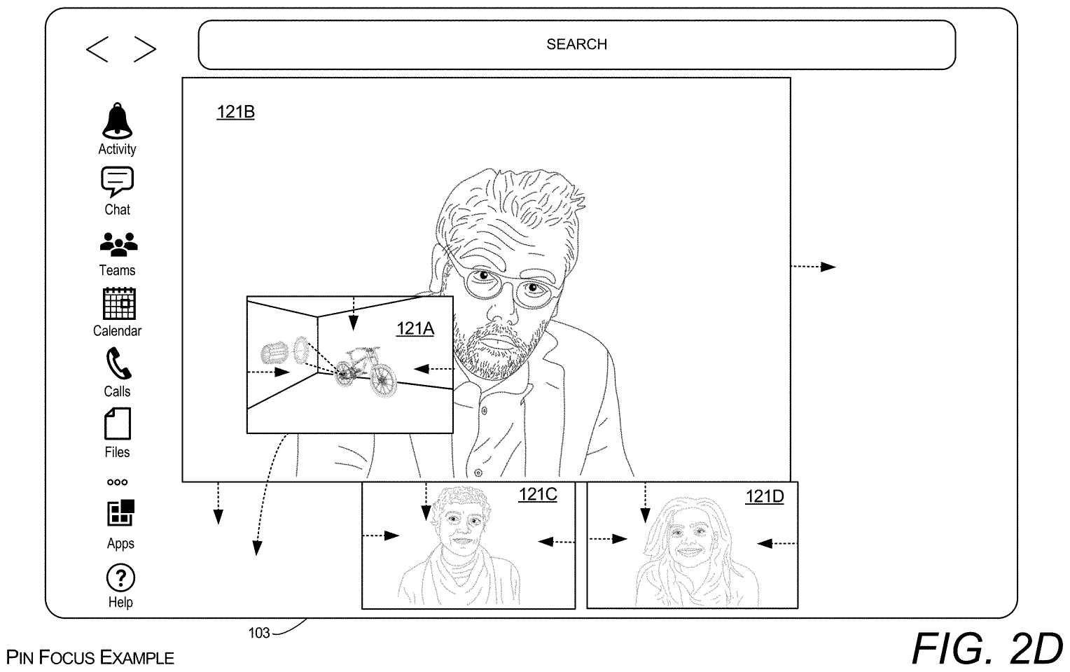

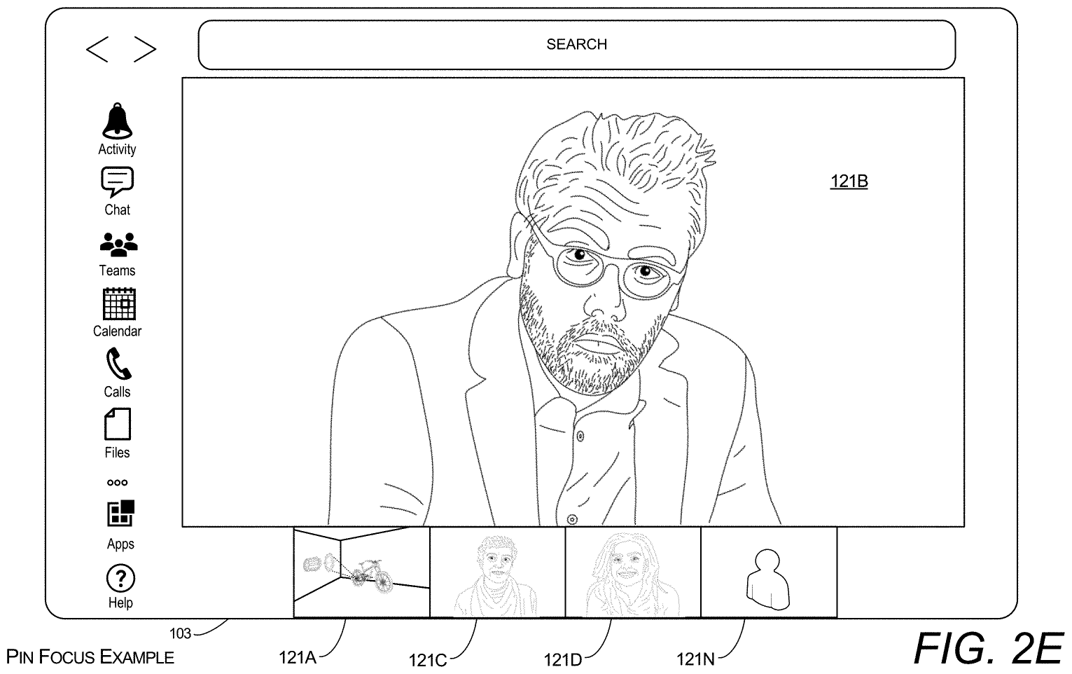

To illustrate aspects of the present disclosure, FIG. 2A through FIG. 9D illustrate a number of example scenarios where different interaction models can be selected based on a user's gaze gesture 131 and other factors, such as a state of a function performed by a computing device. Although the context of the presented examples are described in conjunction with a system managing a collaborative environment, the techniques disclosed herein are not limited to collaborative environments. It can be appreciated that the interaction models that are selected based on a gaze gesture can apply to any computing environment involving a user interface for displaying content.

Referring now FIGS. 2A through 2E, a feature for providing focus to content that is selected by a gaze gesture is shown and described below. In this example, content shared by a participant 104 of a communication session is selected by a gaze gesture. A rendering of the selected content is modified to bring focus to the selected content. For illustrative purposes, this particular feature is referred to herein as a “pin focus” feature, where shared content is “pinned” to a particular location of a viewing area and/or a scale or zoom level of a selected object is modified to make the object more prominent within the user interface 103.

To illustrate aspects of the pin focus feature, consider a scenario where multiple users 104 are communicating through a collaborative environment. In this example, individual participants 104 of a communication session are sharing content displayed within individual display areas 121. A first user 104A (shown in FIG. 1) is sharing a rendering of a live video stream in a first display area 121A. The live video stream includes a rendering of the real-world object 110A and a rendering of a virtual object 110B. The second user 104B, third user 104C, and fourth user 104D are each sharing video streams which are respectively displayed in a second display area 121B, a third display area 121C, and a fourth display area 121D. For illustrative purposes, each display area 121 includes boundaries defining the display area, in which a rendering of a video stream or other content is displayed. It will be describing in more detail below how individual display areas 121 and/or renderings of each object can be located and sized within the user interface 103 based on a user's gaze gesture.

As shown in FIG. 2B, a participant of the communication session, such as the fifth user 104E (shown in FIG. 1), can perform a gaze gesture 131 as shown in FIG. 1 that indicates a gaze target 112. The system can select an object, such as a rendering of another participant, based on the location of the gaze target 112. In this example, it is shown that a gaze gesture positions the gaze target 112 over a rendering of the second user 104B. In response to determining that the gaze target 112 is positioned over a rendering of a particular object, such as the second user 104B, the system can select that particular object.

In some embodiments, the system can select an object in response to determining that the gaze target 112 has a threshold level of overlap with the object. For instance, if the gaze target 112 defines an area within the user interface 103, and a threshold percentage of the area of the gaze target 112 overlaps with a rendering of an object, that object may be selected. The selection of a particular object can also be time-based. For instance, the system may select a particular object within the gaze target 112 in response to determining that the gaze target 112 is held at a predetermined location for a threshold amount of time.

In some embodiments, the selection of a particular object can be time-based and based on a threshold level of overlap between the gaze target 112 and a displayed object. For instance, an object may be selected in response to determining that a gaze target 112 is held at a particular position for three seconds and that the area of the gaze target 112 overlaps with the object focused on by at least 80%. This example is provided for illustrative purposes and is not to be construed as limiting. It can be appreciated that any level of overlap and any threshold amount of time that a gaze target 112 is held in a position or in a region can be utilized for selecting a particular object.

As shown in FIG. 2C, in response to detecting a selection of a particular object, the system 100 can cause the user interface 103 to transition to a layout that brings focus to the selected object. In one illustrative example, a layout of the display areas 121 can be arranged to bring focus to the selected object. This may involve enlarging the display area 121 of the selected object. In some embodiments, focus of a particular object can be provided by resizing or moving display areas for the other objects rendered within the user interface 103. For instance, renderings of objects that are not selected by a gaze gesture, can be moved to the perimeter of the user interface 103 or towards less prominent sections of the user interface 103. In addition, renderings of objects that are not selected by a gaze gesture can be reduced in size.

In an example shown in FIG. 2C, the display areas of objects that are not selected by a gaze gesture, such as the first display area 121A, the third display area 121C, and the fourth display area 121D, are reduced in size. In addition, the display area 121B of the selected object is enlarged. As shown by the arrows of the dashed lines, the display area 121B of the selected object is transitioned to a more prominent location, e.g., the center of the screen or a centralized location, within the user interface 103. A centralized location can be a location that is closer to the center of the user interface 103 than a border of the user interface 103. Also shown by the arrows of the dashed lines, the display areas of the objects that are not selected by a gaze gesture are transitioned to the perimeter of the user interface 103.

FIG. 2D illustrates a continuation of the transitions that are shown in FIG. 2C. In this illustrative example, the first display area 121A, the third display area 121C, and the fourth display area 121D are transitioning to the bottom of the user interface 103. In addition, the first display area 121A, the third display area 121C, and the fourth display area 121D are in the process of being reduced in size, while the second display area 121B is increased further in size. The second display area 121B is also positioned near the center of the user interface 103.

FIG. 2E illustrates the resulting layout of the user interface 103. In this example, the second display area 121B is increased in size and positioned near the center of the user interface 103. In addition, the first display area 121A, the third display area 121C, and the fourth display area 121D are positioned as thumbnail viewing areas near the bottom of the user interface 103. The reconfigured layout of the user interface 103 can include other user interface elements. In this example, a new display area 121N is shown. Such a graphical element can be introduced to indicate the presence of other users within the collaborative environment. This example is provided for illustrative purposes and is not to be construed as limiting. It can be appreciated that the display areas can be placed in other locations and configured with other sizes. For instance, the first display area 121A, the third display area 121C, and the fourth display area 121D can be positioned along the sides of the user interface 103 or along the top edge of the user interface 103.

In some configurations, the display areas of the objects are arranged according to a priority level of the object displayed in each display area. In this example, the first display area 121A, the third display area 121C, and the fourth display area 121D are arranged from left to right indicating a higher priority for the objects that are displayed on the left portion of the user interface 103 versus objects that are displayed on the right portion of the user interface 103.

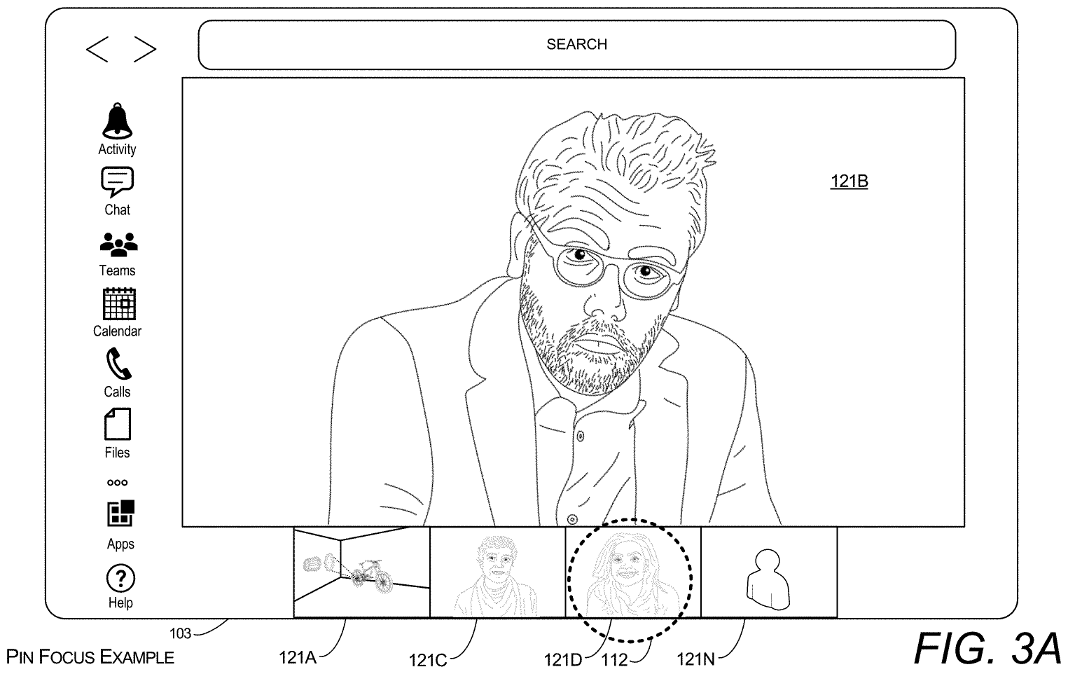

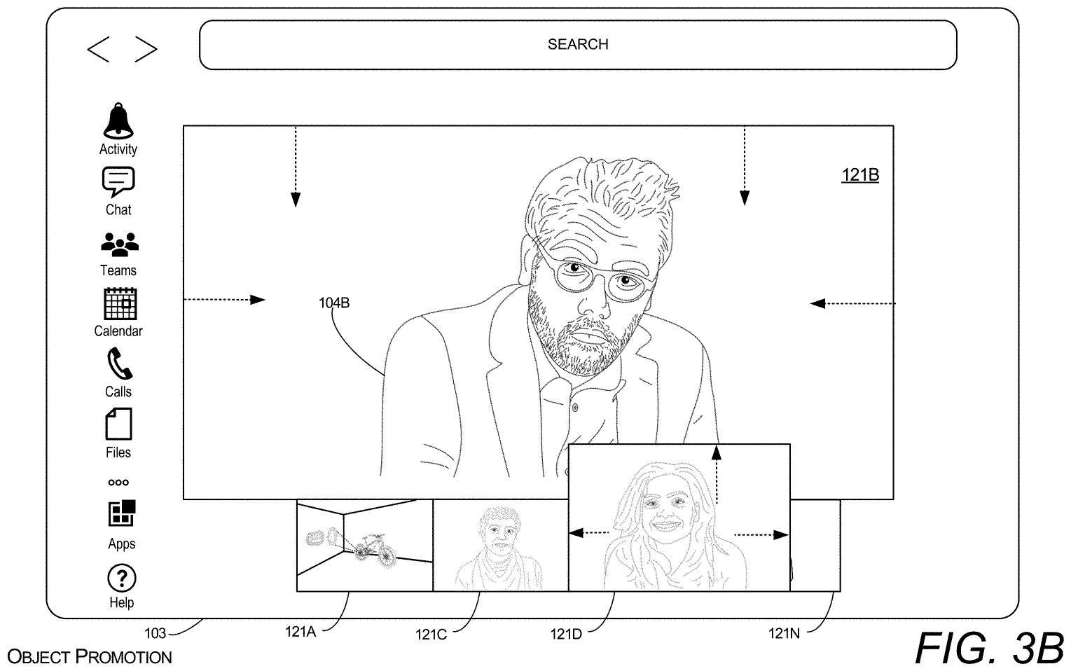

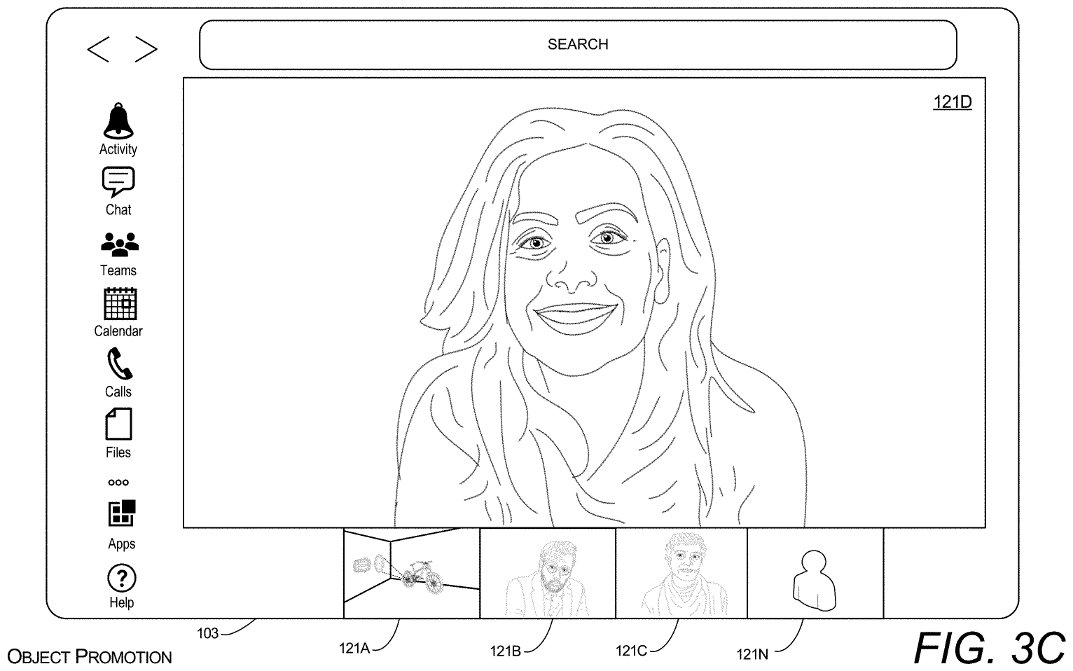

In some configurations, a gaze gesture can also be utilized to promote the display of objects. One illustrative example of this process is shown in FIGS. 3A through 3D. In this illustrative example, an object is selected from a secondary display area, such as the thumbnail viewing area at the bottom of the user interface. In such an embodiment, when an object depicted within a secondary display area is selected, the arrangement of the user interface can be modified to bring focus to the selected object.

As shown in FIG. 3A, a participant of the communication session, such as the fifth user 104E, can perform a gaze gesture 131 that indicates a gaze target 112. The system can select an object, such as a rendering of another participant, based on the location of the gaze target 112. In this example, it is shown that a gaze gesture positions the gaze target 112 over a rendering of the fourth user 104D in the display area 121D. In response to determining that the gaze target 112 is positioned over a rendering of a particular object, such as the rendering of the fourth user 104D, the system can select that particular object.

As shown in FIG. 3B, in response to the selection of an object, e.g., the rendering of the fourth user 104D in the display area 121D, the system 100 can cause the user interface 103 to transition the layout to bring focus to the selected object. In this illustrative example, the layout of the display areas 121 can be arranged to bring focus to the selected object. This embodiment involves enlarging the display area 121D of the selected object and repositioning the display area 121D in a more prominent location, e.g., a central location, within the user interface 103. As shown, the second display area 121B begins a transition to reduce the size of the second display area 121B. The second display area 121B is also repositioned in the collection of views near the bottom of the user interface 103.

FIG. 3C illustrates the resulting layout of the user interface 103 from the transition shown in FIG. 3B. In this example, the rendering of the selected object within the fourth display area 121D is increased in size and positioned in a central location of user interface 103. This embodiment allows focus to be drawn to the selected object while minimizing focus on objects that were not selected by the gaze gesture. This example is provided for illustrative purposes and is not to be construed as limiting. It can be appreciated that other display properties can be modified to draw focus object selected by a gaze gesture. For instance, modification of a display property suggests a brightness level or a contrast level can be adjusted to draw focus to a particular object. A pin focus function for bringing focus to a selected object can also include transitioning a rendering of a selected object to a centralized location within a user interface. A centralized location can be a location that is closer to the center of the user interface 103 than a border of the user interface 103.

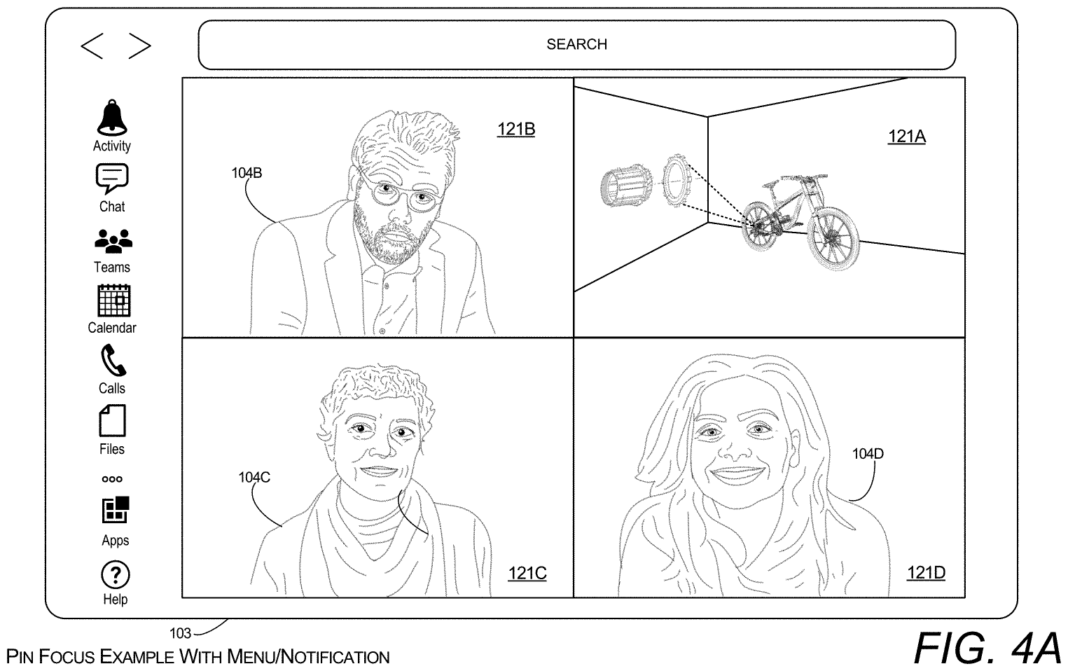

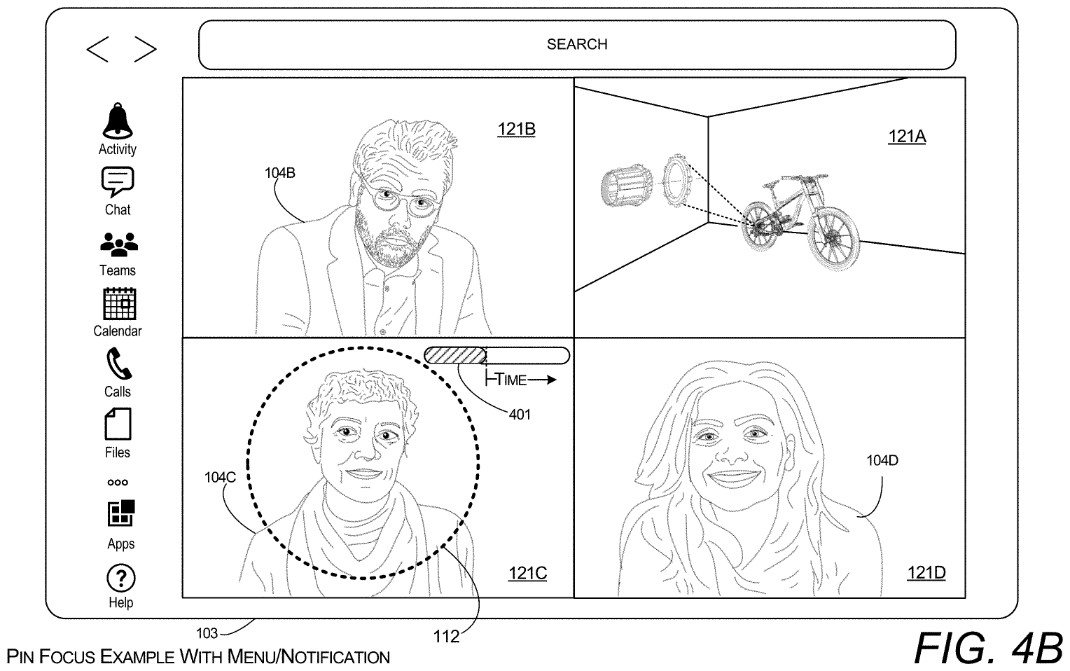

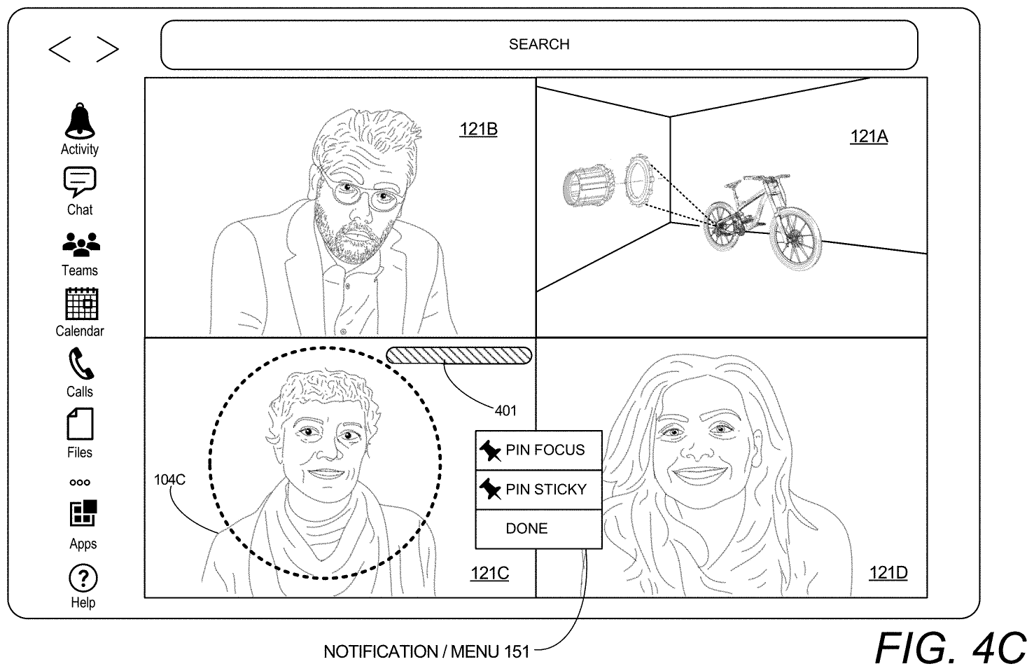

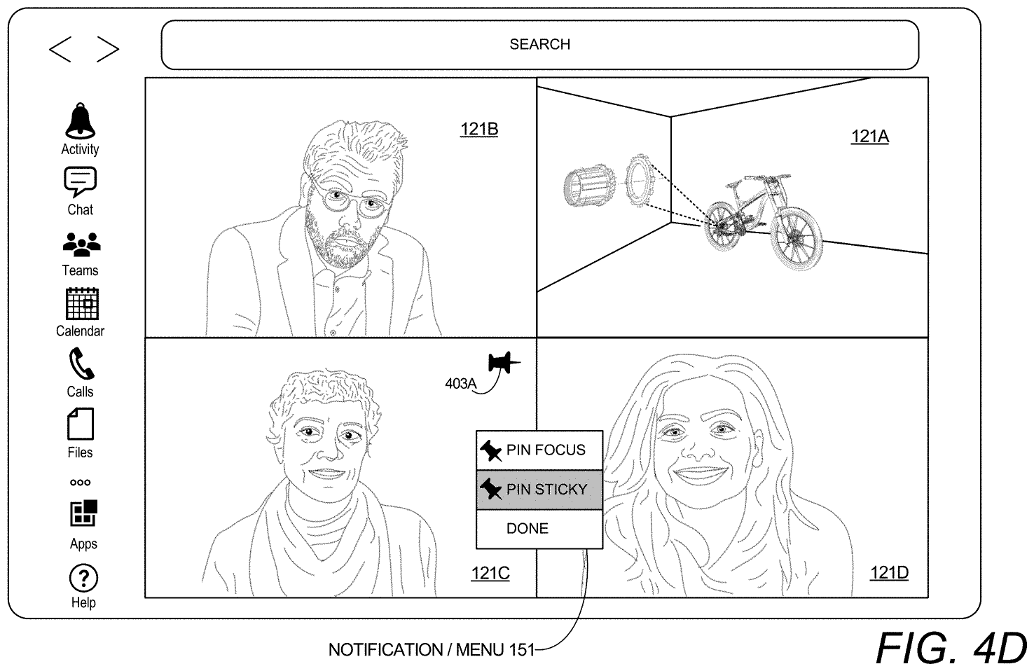

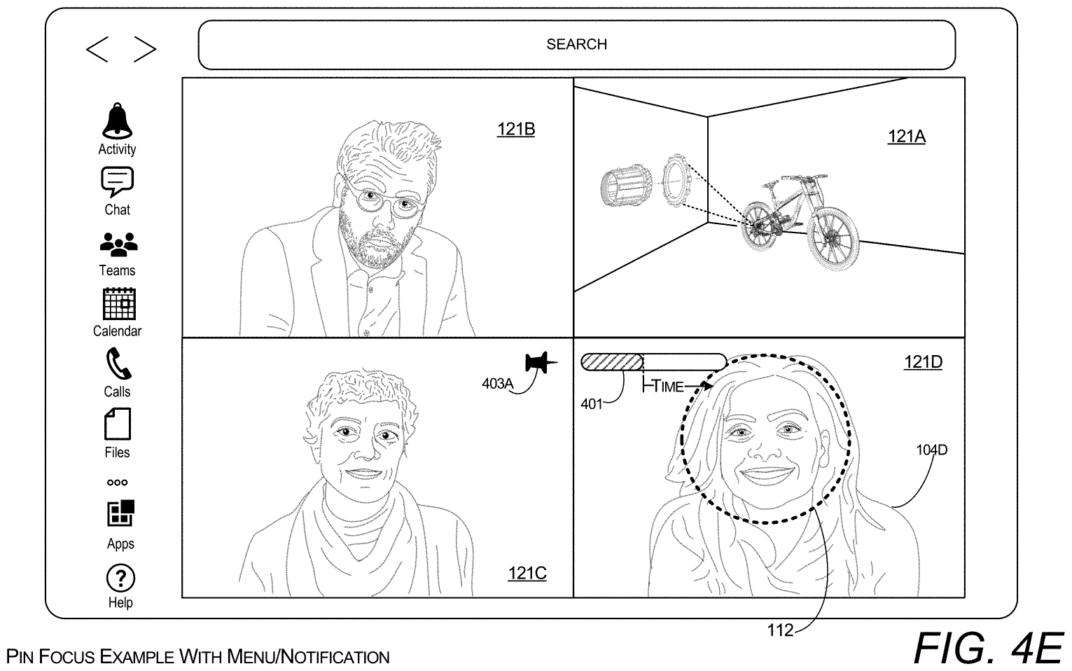

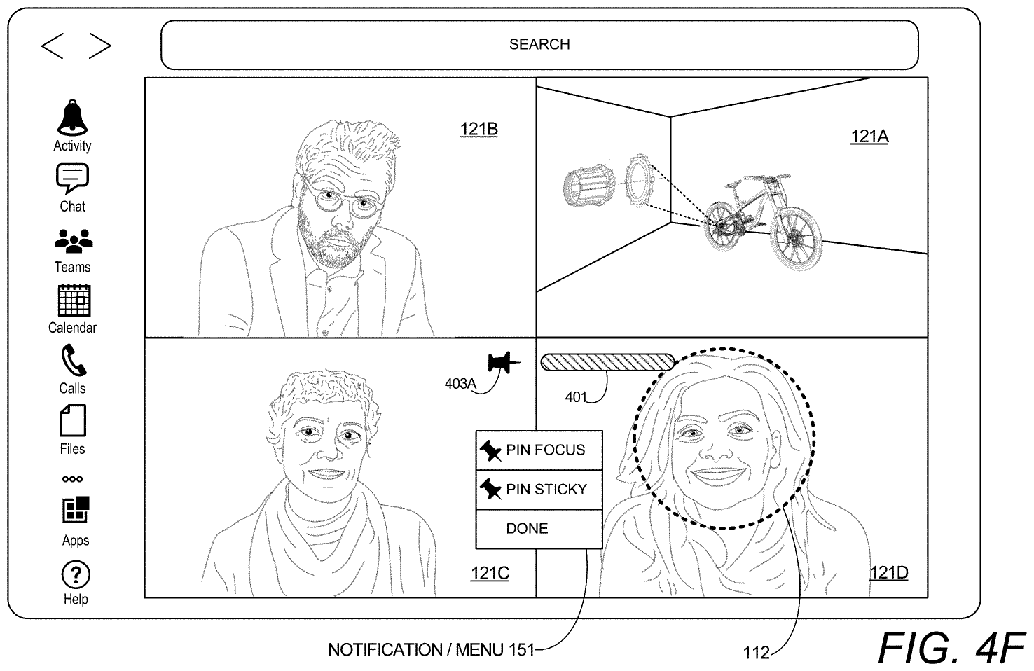

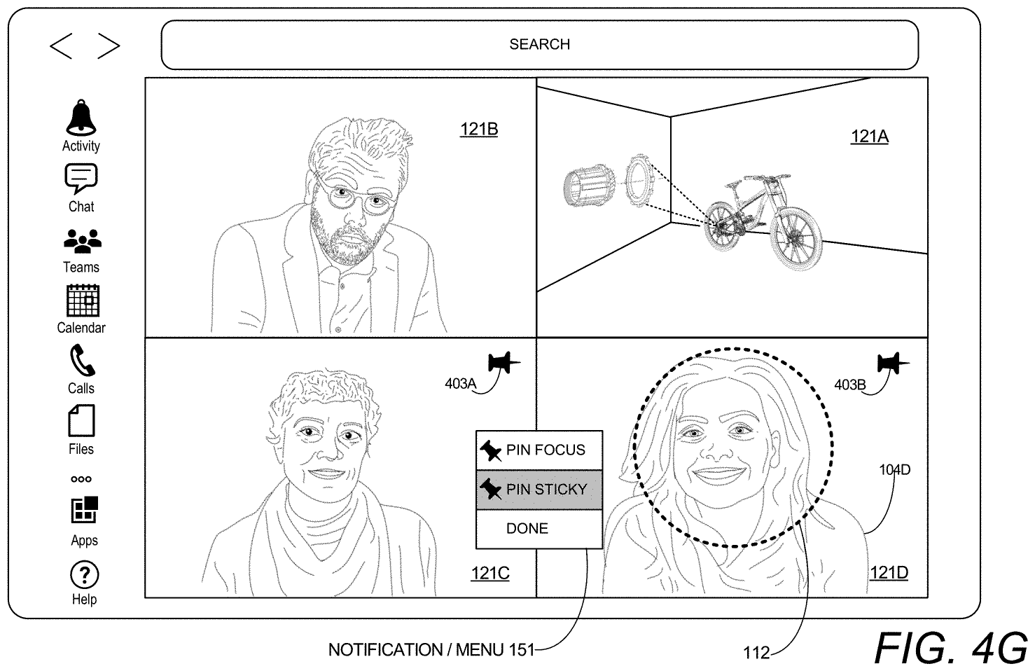

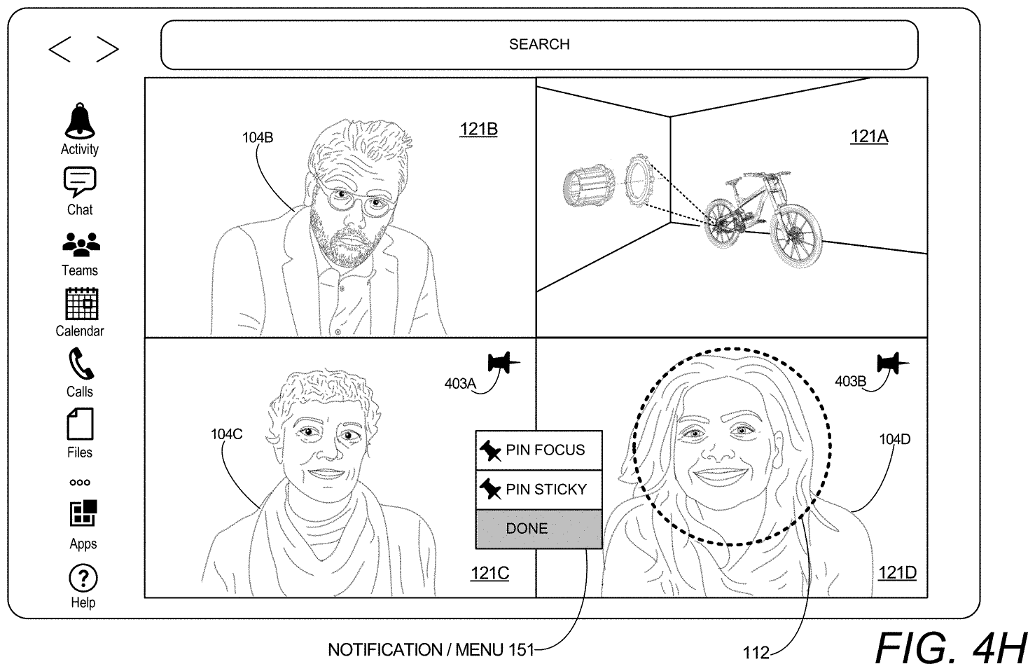

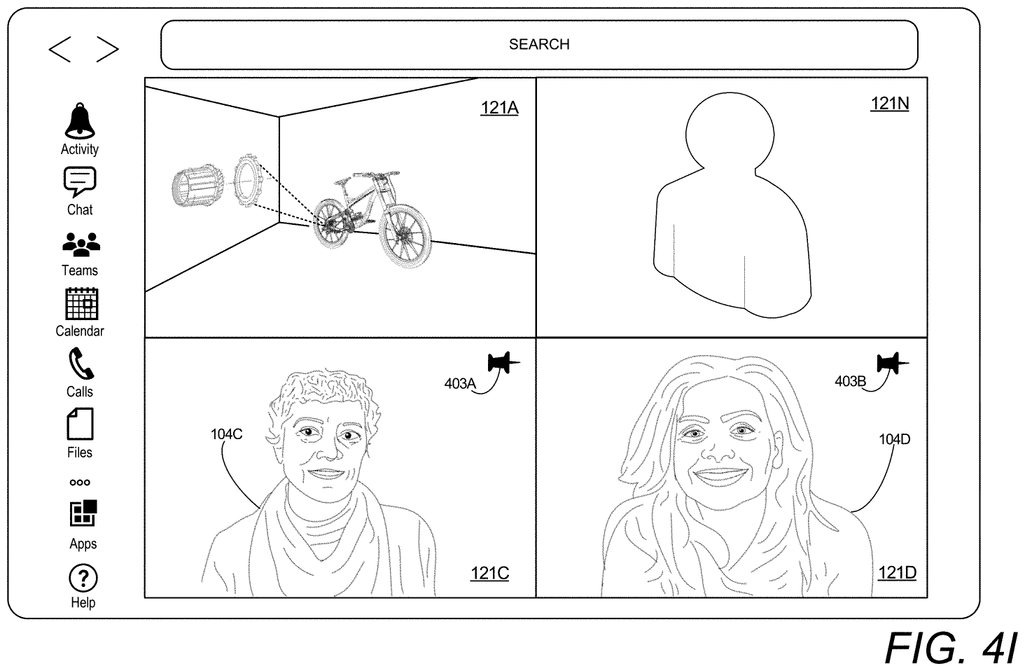

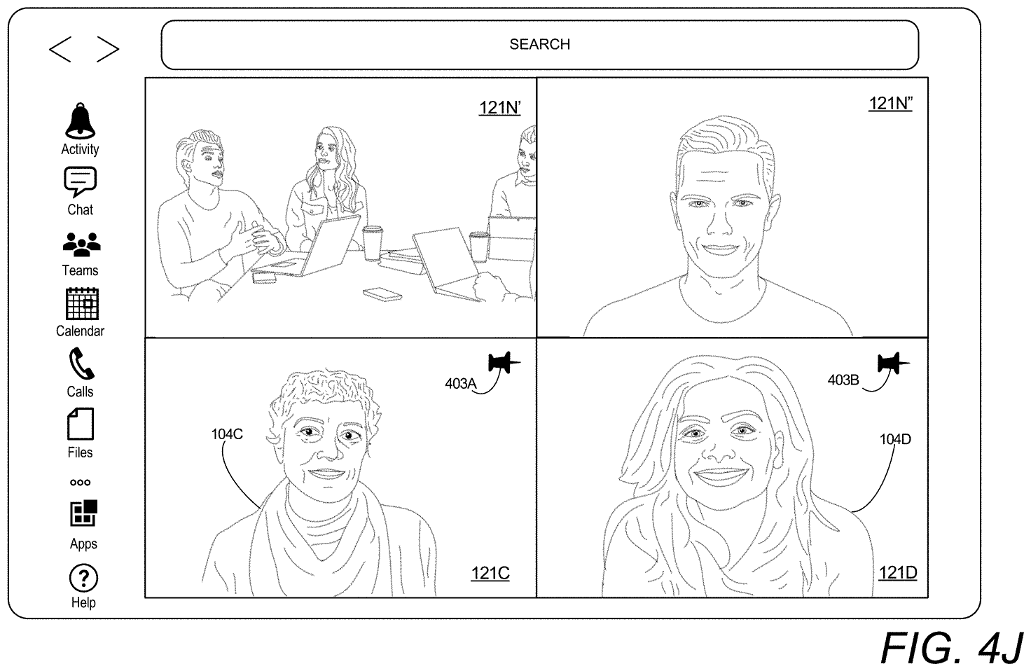

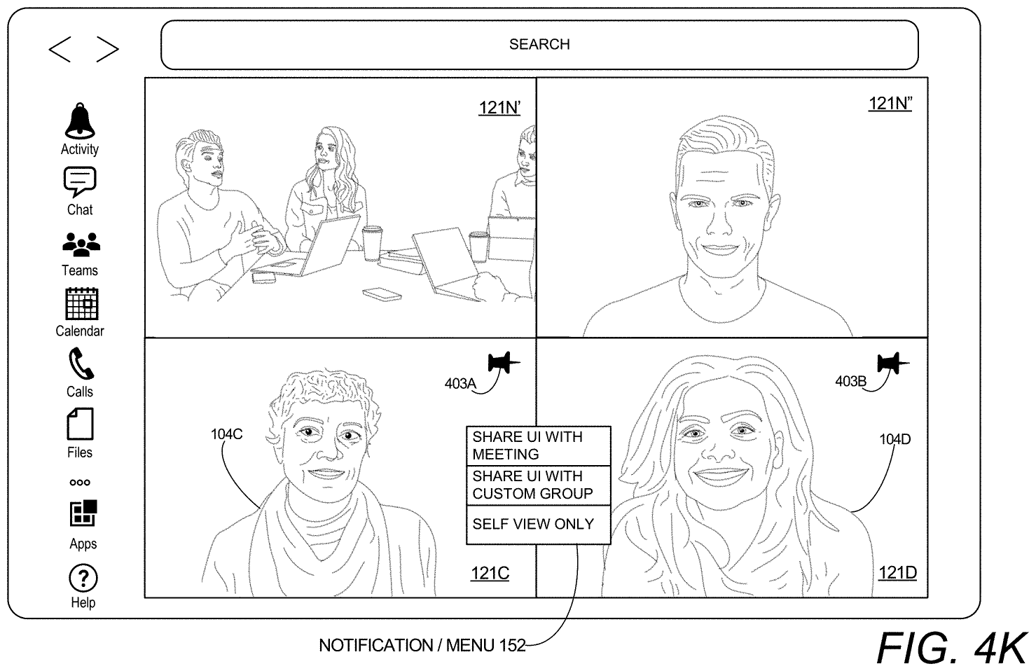

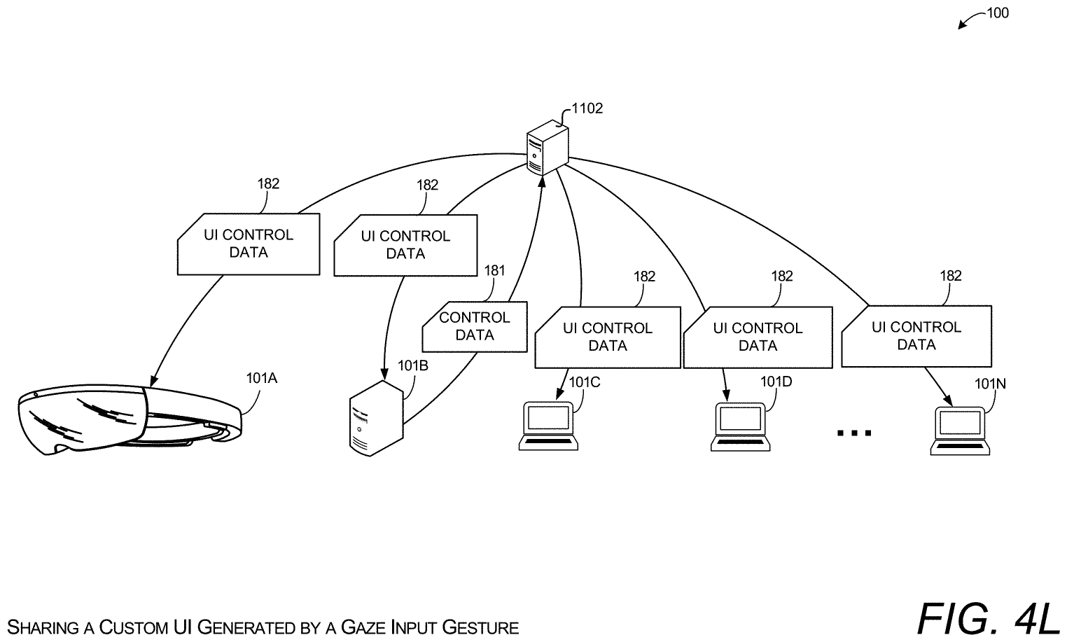

As summarized above, some configurations disclosed herein can utilize menus or notifications to assist a user in performing a gaze gesture. Generally described, when a system detects a gaze gesture that indicates a particular gaze target within a location, the system can generate a notification or menu to prompt the user to perform supplemental gestures. In the illustrative example of FIGS. 4A through 4L, when a gaze target is detected the system prompts the user to provide a supplemental input, such as a voice input, a touch gesture, or any other input provided by an input device. This allows the system to perform more specific operations with respect to a selected object. In the example described below, supplemental inputs provided in conjunction with the gaze gesture can allow specific user interface layouts to be generated. In addition, supplemental inputs provided in conjunction with the gaze gestures can allow for other functionality to be performed, which may include operations for sharing the customized layout with other users.

Although the examples disclosed herein describe an adaptation of a layout of display areas, the scope of the techniques disclosed herein apply to any implementation that arranges renderings based on a gaze gesture. The techniques disclosed herein apply to any type of modification to a user interface displaying a number of different objects, where individual objects are rearranged and/or scaled based on a user's eye gaze gesture. Thus, any example described as resizing or moving a display area can be interpreted as resizing or moving any rendering of an object.

As summarized herein, the system can select an object in response to determining that a gaze target meets one or more criteria with respect to that object. The criteria can include a number of factors. For instance, the system can determine that a gaze target meets one or more criteria in response to determining that the gaze target remains within a location having a threshold amount of overlap of a rendering of an object for a predetermined time. In another example, a system can determine that a gaze target meets one or more criteria with an object in response to determining that the gaze target remains within a predetermined distance from a particular point in the rendering of the object. For instance, a system may select a particular pixel or a collection of pixels that are near the center of an object. If the center of the gaze target, or an edge of the gaze target, is within a predetermined distance from that particular pixel or collection of pixels within a predetermined time, the system may select that object.

In other embodiment, the system can prompt a supplemental user input to be provided to assist in the selection of an object. For instance, a system can determine that a gaze target meets one or more criteria when the system determines that the gaze target remains within a location having a threshold amount of overlap with a rendering of an object for a predetermined time period, and when the system receives a voice input confirming the selection of the object. For instance, if a user is looking at a particular object and says a predetermined word or command, e.g., “select,” the system may select that object in response to receiving such a supplemental input. Examples illustrating these embodiments are shown in FIGS. 4A through 4L and described in more detail below.

FIG. 4A illustrates a user interface 103 showing a first stage of a process for selecting an object. Similar to the examples described above, the user interface 103 displays a plurality of renderings, e.g., renderings of streams provided by the first user 104A, the second user 104B, the third user 104C, and the fourth user 104D, shown in FIG. 1.

As shown in FIG. 4B, a participant of the communication session, such as the fifth user 104E (shown in FIG. 1), can perform a gaze gesture 131 that indicates a gaze target 112. The system can select an object, such as a rendering of another participant, based on the location of the gaze target 112. In this example, it is shown that a gaze gesture positions the gaze target 112 over a rendering of the third user 104C. In response to determining that the gaze target 112 meets one or more conditions with a particular object, such as the rendering of the third user 104C, the system can select that particular object.

The one or more conditions can be based on a time period. In one illustrative example, as shown in FIG. 4B, the system can measure the amount of time a gaze target overlaps with a particular object. In addition, the system can display a graphical element 401 indicating an elapsed time the gaze target overlaps with a particular object. This example illustrates a progress bar showing the elapsed time in which the gaze target overlaps the rendering of the third user 104C.

As shown in FIG. 4C, once the elapsed time has passed, the system can display a notification 151. The notification can list a number of different options for the user to select. In some configurations, the notification 151 can provide a description of available functions. The system can receive a selection of one of the functions by the use of a gesture, a voice command or another form of user input. In some configurations, the notification 151 can include a menu of selectable items. The system can be configured to perform one or more of the functions based on user interaction with the notification 151. In this example, the notification 151 provides two options for the user to invoke a “pin focus” function or a “pin sticky” function.

In response to a selection of the pin sticky function, as shown in FIG. 4D, the system can control the rendering of a selected object, such as the rendering of the third user 104C, to remain at a predetermined size and/or position to allow users to maintain focus on that selected object.

In response to a selection of the pin sticky function, the system can lock the rendering of the selected object into a particular position. Thus, when other adjustments are made to the user interface 103, the rendered object that is locked into a particular position remains fixed while other renderings are adjusted.

For illustrative purposes, in the present example, it is shown that the user selects the pin sticky option for the selected object, e.g., the rendering of the third user 104C. As shown in FIG. 4D, in response to a user selection of a particular function, the system can render a graphical element 403A to indicate the selection. Once a user selects a function for an object, the system can analyze additional gaze gestures performed by the user.

As shown in FIG. 4E, the system can determine a gaze target 112 for another object to be selected. In this example, the position of the gaze target 112 indicates a selection of the rendering of the fourth user 104D. Similar to the example described above, the system can determine if the gaze target 112 meets one or more criteria with respect to an object. As shown in the transition between FIG. 4E and FIG. 4F, the system determines if a time period has elapsed. Once the time period elapses, the system can display a graphical element 401. The system also generates a notification 151 in response to determining that the time period has elapsed. Similar to the example above, the notification 151 indicates a number of available functions to be performed on the selected object. Based on a user input, such as a voice command, a touch gesture, or any other type of input gesture, the system can select one of the available functions. A gaze gesture can also be utilized to select one of the functions displayed in a notification 151.

For illustrative purposes, in the present example, it is shown that the user selects the pin sticky option for the selected object, the rendering of the fourth user 104D. As shown in FIG. 4G, in response to a user selection of a particular function, the system can render a graphical element 403B to indicate the selection. Once a user selects a function for an object, the system can analyze additional gaze gestures performed by the user. As shown in FIG. 4H, to illustrate aspects of this example, it is shown that the user has indicated a selection of the last menu option, “DONE,” which indicates to the system that the user has completed the selection process using a gaze gesture.

In response to the selection of the last menu option, “done,” as shown in FIG. 4I, the system can perform the selected functions for the selected objects. In this example, the renderings for the third user 104C and the fourth user 104D are processed according to the pin sticky function. In this example, the renderings for the third user 104C and the fourth user 104D are controlled to be a particular size and/or location to help users maintain focus on these objects while other adjustments are made to the user interface. Adjustments to the user interface can include a rearrangement of displayed objects. For instance, consider a situation where the user interface is adjusted periodically to show the most active objects. Thus, if a participant of a meeting is determined to be a dominant speaker, that participant may be moved to a particular location of the user interface. In general, the arrangement of objects displayed in the user interface may be adjusted to rank each displayed person based on a level of their contribution to a conversation. However, every object that is subject to a pin sticky function is controlled to maintain its position and/or size even though the user interface may arrange other objects based on level of activity.

FIG. 4J illustrates another example of a resulting user interface for the present example. In this example, new objects are displayed based on the level of activity with respect to those objects. In particular, a new display area 121N′ is displayed in the upper left quadrant of the user interface based on level of activity with respect objects displayed in the new display area. In addition, another display area 121N″ is displayed in the upper right quadrant of the user interface based on the level of activity with respect to the object displayed in the other new area. Despite the level of activity that causes changes within the user interface, a computing device managing the user interface can maintain a size and/or position for the renderings for the “pinned” objects, e.g., the renderings of the third user 104C and the fourth user 104D.

In addition to functionality that brings focus to a rendering of a selected object, the techniques disclosed herein can provide other functionality based on the gaze gesture. For instance, as shown in FIG. 4K, a system can provide a supplemental notification 152 for a number of different functions that enable a system to share a reconfigured user interface with other participants of a communication session, share a reconfigured user interface with specific users, or instruct a system to control the reconfigured user interface to be displayed only on a local device. In response to a selection of an option of such a notification, the system can share the reconfigured user interface with other participants of a communication session. Thus, in addition to displaying contextually relevant menu options based on an object type, a system can also select and display contextually relevant menu options based on a state of available functions. In the example of FIG. 4K, the state of a function of reconfiguring a user interface has completed the process of rearranging the user interface. Based on this current state of the reconfiguration function, the system provides the supplemental notification 152 that provide a new set of functions, which is different than the previous notifications 151 that provide access to the original set of functions.

As shown in FIG. 4L, once a user selects a particular function for sharing a reconfigured user interface with other users of the communication session, a server 1102 of the system 100 can receive control data 181 defining the reconfigured user interface and distribute user interface control data 182 defining the reconfigured user interface to select devices. In this example, the user of the second device 101B has selected a function of the supplemental notification 152 that allows each user of a communication session to update the session data using the reconfigured user interface.

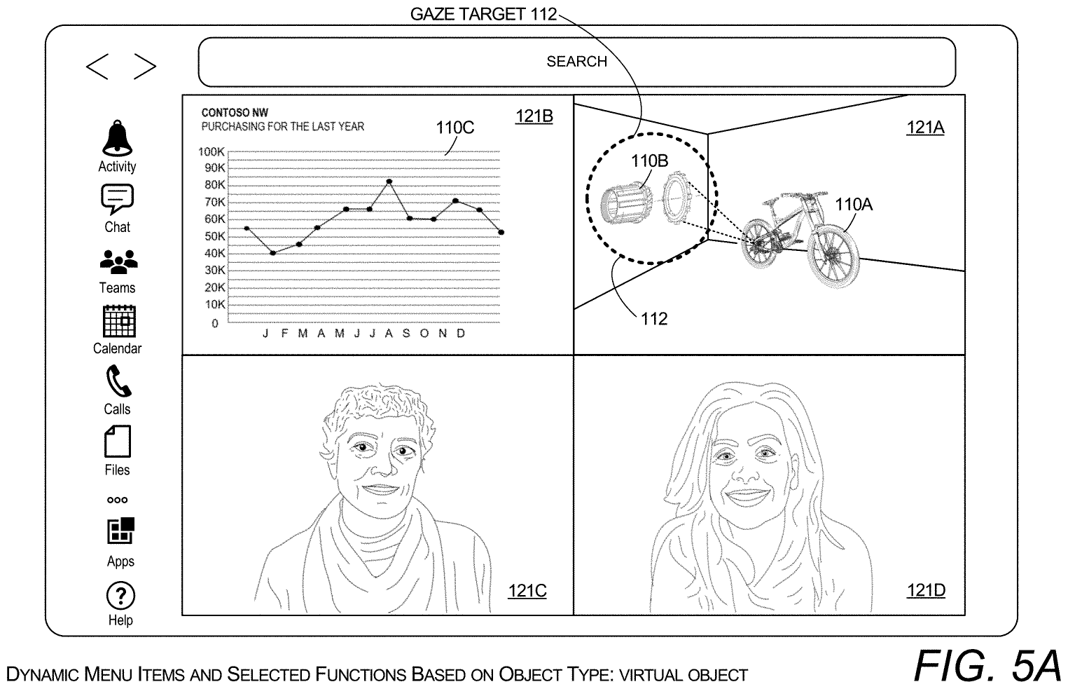

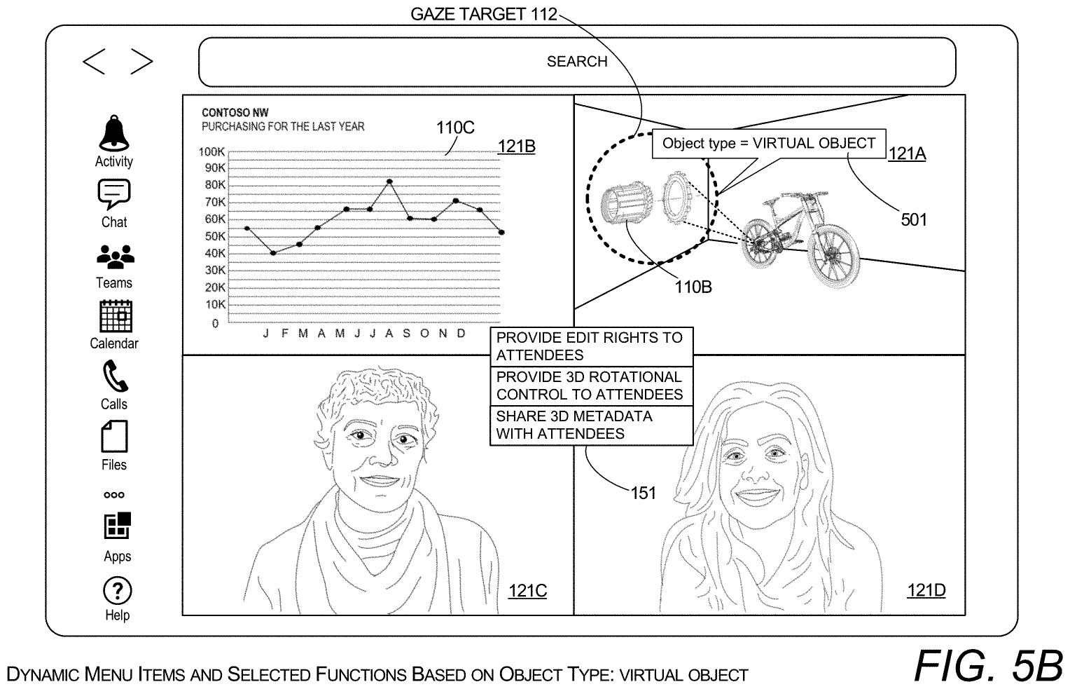

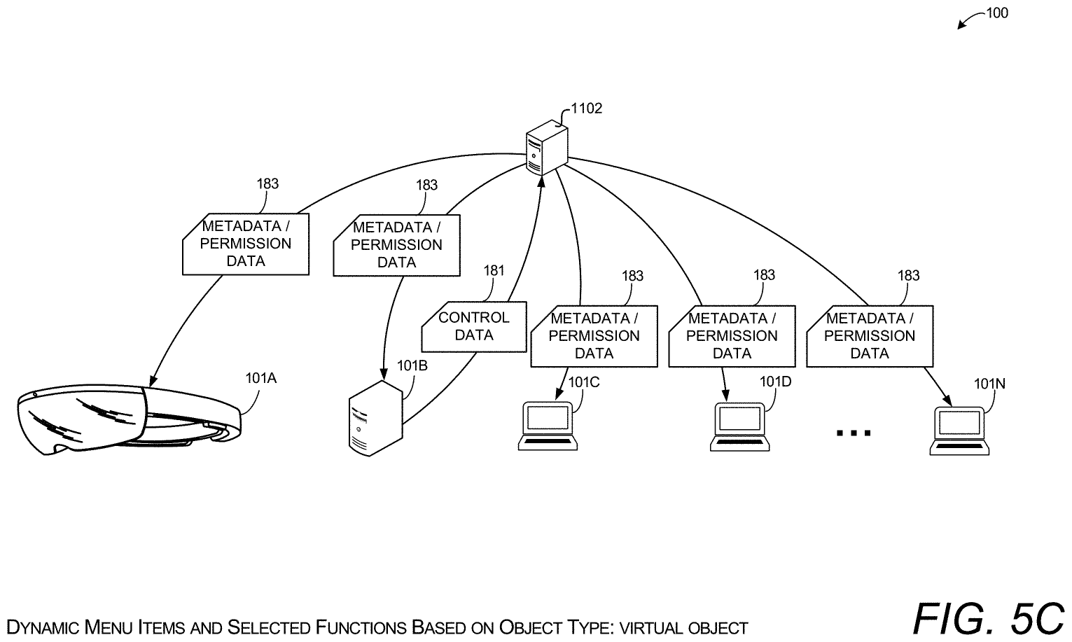

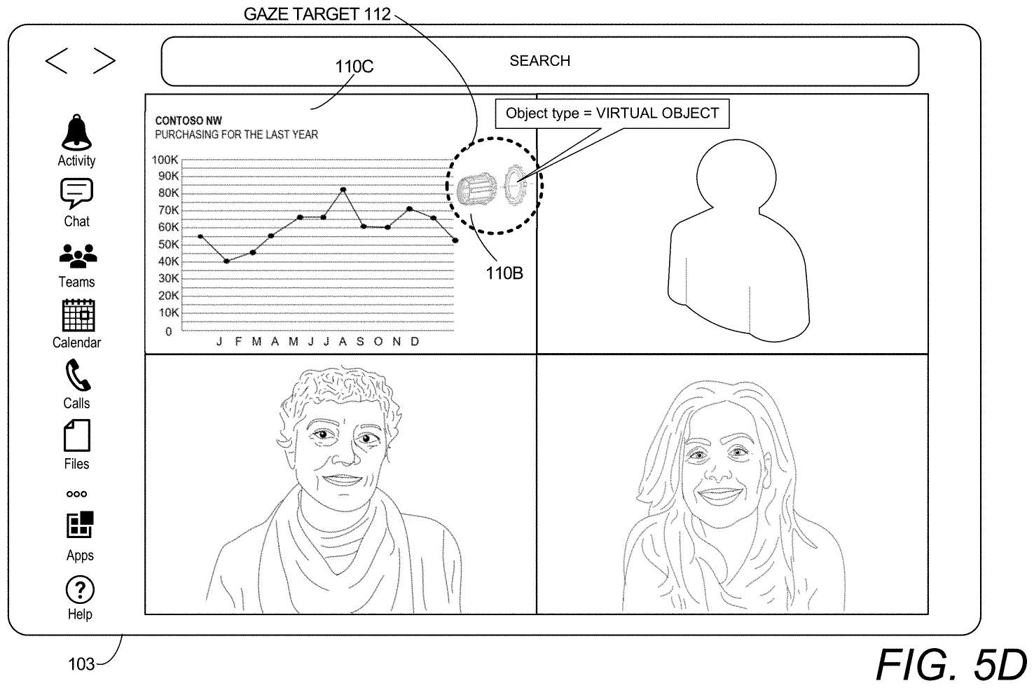

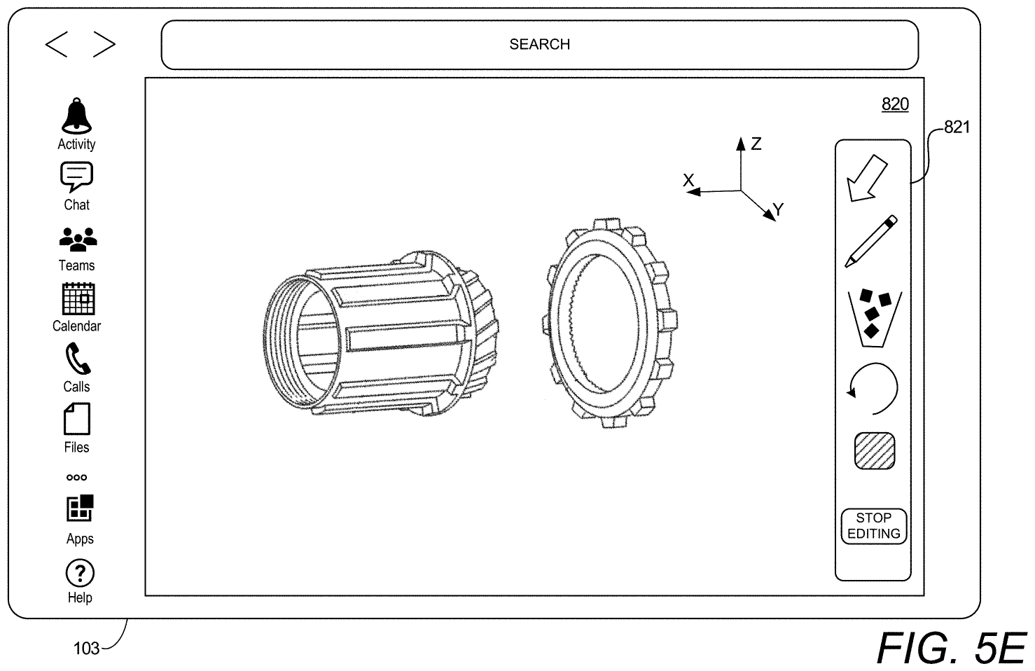

In some configurations, the system can take a number of different actions based on an object type of an object that is selected by an eye gaze gesture. For example, a system can determine that an object selected by a gaze gesture is a virtual object. Based on such a determination, specialized menu items can be selected to enable a user to interact with that particular object type. For a virtual object, for example, the system may select a set of functions that are specific to viewing and/or editing the virtual object, which may include allowing users to rotate or resize a virtual object. For another type of object, such as a document or spreadsheet, the system may select a set of functions that are specific to viewing and/or editing such content data. For a real-world object, such as the bicycle shown in FIG. 1, in response to a user selection of such an object using an eye gaze gesture, the system may select a set of functions that are specific to modifying a view of the real-world object. Special functions such as a zoom or pan gesture may be selected and made available to a user. Other functions for changing other display properties such as a brightness level or a contrast level may also be made available to a user. By providing specific functions that are suited for a particular object type, and also providing notice of an object type, user interaction with a computing device may be improved. The display of a particular object, may not readily allow users to identify the object type and thus providing a description of the object type may allow users to make more informed decisions on a particular interaction users may have with the computing device. These embodiments are shown in FIGS. 5A-5C, 6A-6C and 7A-7E.

FIGS. 5A-5C illustrate an example scenario where a user selects an object that is a virtual object and the system selects a set of functions that is based on the object type. In FIG. 5A, the first display area 121A includes a view of a physical object 110A and a virtual object 110B. In this example, the user performs a gaze gesture that positions a gaze target 112 over the virtual object 110B. As shown in FIG. 5B, in response to determining that the object type is a virtual object, the system generates and displays a notification 151 describing the object type and a set of functionality specific to the object type. In addition, the system can generate a graphical element 501 for providing notice of the object type. The notification 151 can provide a number of different options a user can select for performing the available functions. Functions may be selected by an interaction with the notification 151 or by another type of input such as a voice input or another type of input gesture. As shown in FIG. 5C, in response to a selection of a particular function, the computing device receiving the input can provide control data 181 to a server 1102 and the server can distribute metadata or permission data 183 to other computing devices to perform the selected function.

In some configurations, the system can change the mode of an application based on the selection of a virtual object. In one illustrative example, the system can change the mode of an application based on the selection of a virtual object that is embedded within a content object. An illustration of this feature is shown in FIG. 5D and FIG. 5E. In this example, as shown in FIG. 5D, a content object 110C comprises a link to data defining the virtual object. Such an embodiment can include a document with a chart or other content and a representation of a virtual object 110B that provides link access to the data defining the virtual object. Also shown in FIG. 5D, the user selects the virtual object 110B using a gaze gesture that causes the system 10 define the gaze target 112.

In response the selection, the system can change the mode of an application. For example, the application managing the user interface 103 can transition from a collaboration mode shown in FIG. 5D to a specialized editing mode shown in FIG. 5E. In this example, in response to the user's gaze gesture selecting the virtual object 110B, data defining the virtual object is obtained displayed within the user interface 103. While in the specialized editing mode, the application can display the virtual object and provide specialized tools 821 for editing the virtual object. The specialized tools 821 can be provided by the application, a set of plug-in modules, or from an external application such as AutoCAD. When the data defining the object has been, the application or one of the modules providing the specialized tools can save the updated data defining the object and distribute the updated data to one or more users based on their roles and/or permissions. Thus, a number of manual steps for obtaining and editing data can be avoided by the use of an eye gaze gesture. This example is provided for illustrative purposes and is not to be construed as limiting. It can be appreciated that other types of user interface configurations and other mode transitions can be utilized to obtain and edit other types of data objects.

In one illustrative example, one of the available functions specific to a virtual object allows a user to control permission respect to the virtual object. The user can use a voice command to grant a specific user, or specific groups of users, permissions to change a display setting with respect to the virtual object or edit the virtual object. In such an embodiment, control data 181 provided to a server 1102 can cause the server to issue permission data 183 to respective computing devices. The voice command or other gestures such as a gaze gesture can be used to grant specific permissions for specific users to control a view of a virtual object. For instance, the second user 104B (shown in FIG. 1) of the second computing device 101B can issue the command “Grant User X permissions to rotate a view of a virtual object.” In response to such command, the system 100 can identify a computing device associated with User X and cause the server 1102 to communicate permission data 183 to a computing device associated with User X.

In other examples, the system may display an available function that allows a user to provide editing rights to attendees. In response to receiving a selection of this functionality, the system can allow each participant of a communication session to edit the model data that is used to display the virtual object. Permissions can be communicated as shown in FIG. 5C. In another example, the system may display an available function that allows a user to share the three-dimensional metadata defining the object with one or more participants of a communication session. In response to receiving a selection of this functionality, the system can allow each participant of a communication session to receive a copy of the data defining the object.

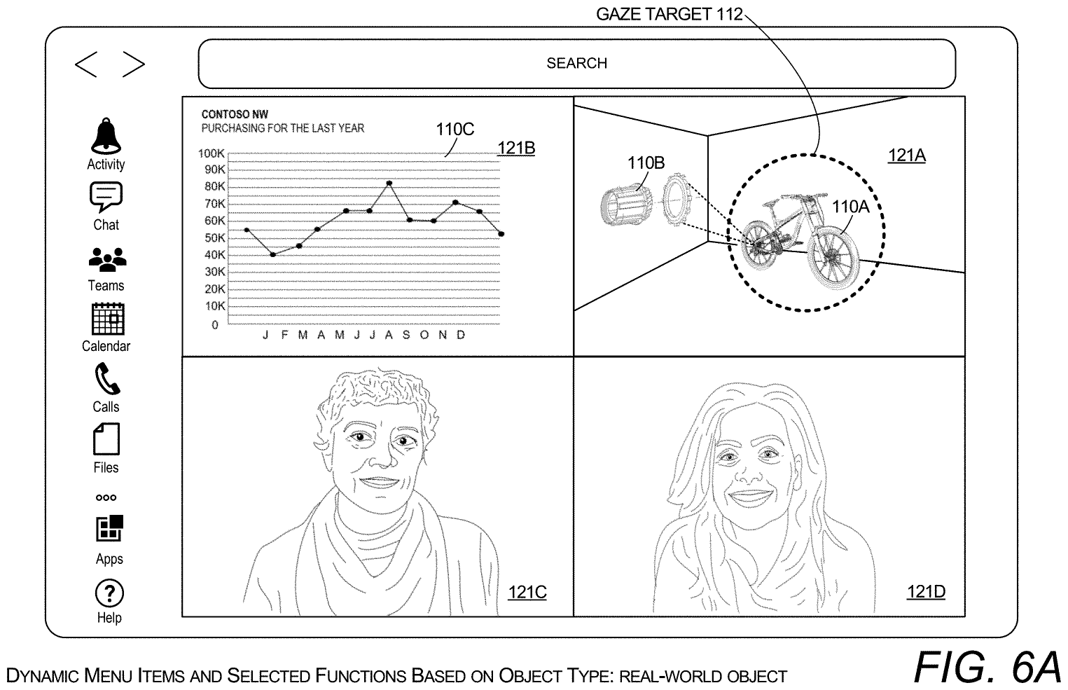

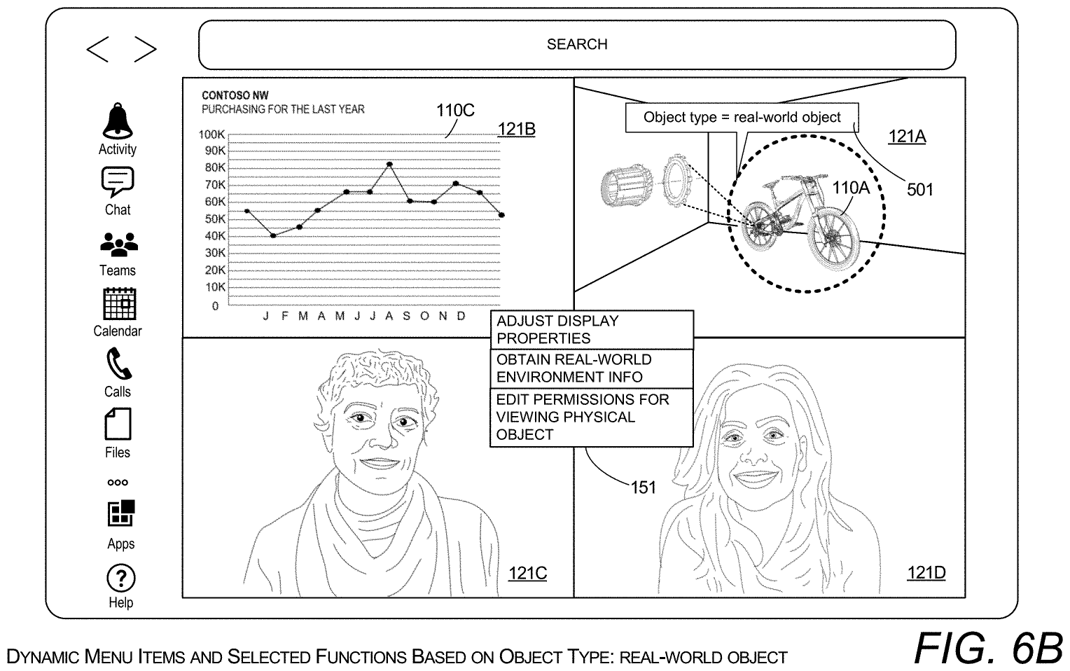

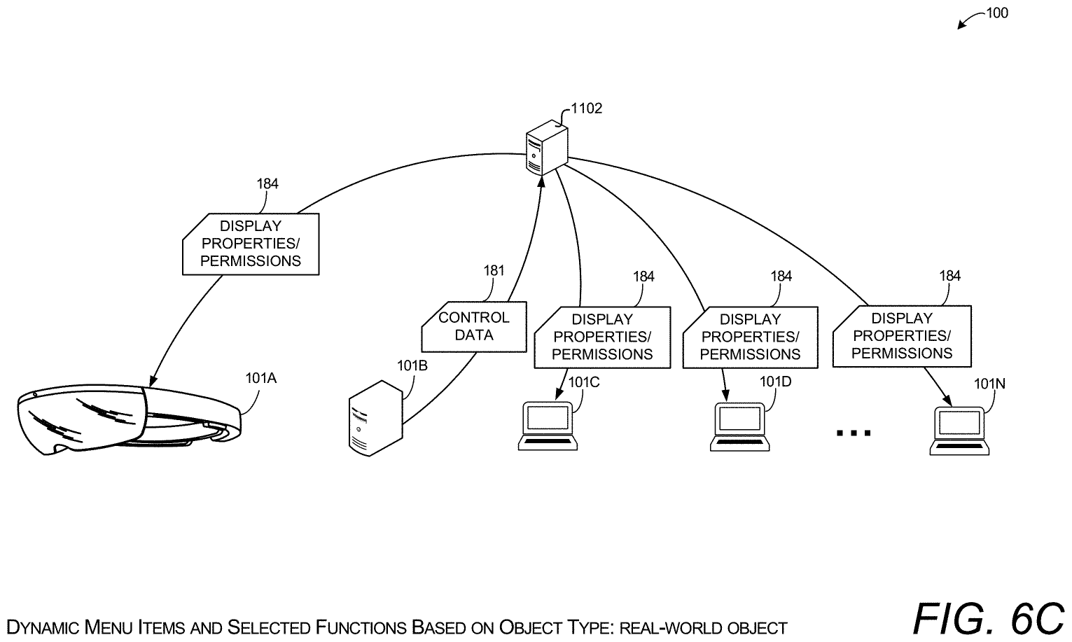

FIGS. 6A-6C illustrate an example scenario where a user selects an object that is a physical object (real-world object) and the system selects a set of functions that is based on the object type. In FIG. 6A, the first display area 121A includes a view of a physical object 110A and a virtual object 110B. In this example, the user performs a gaze gesture that positions a gaze target 112 over the physical object 110A. As shown in FIG. 6B, in response to determining that the object type is a physical object, the system generates and displays a notification 151 describing object type and a set of functionalities specific to the object type. In addition, the system can generate a graphical element 501 for providing notice of the object type. The notification 151 can provide a number of different options a user can select for performing the available functions. Functions may be selected by an interaction with the notification 151 or by another type of input such as a voice input or another type of input gesture. In this example, the selected functions can be determined in response to receiving mesh data defining the physical object 110A and the physical environment 111. Any function suitable for interacting with the physical object 110A or the physical environment 111 can be selected for the notification. In one example the notification can display options for changing display properties such as the brightness or contrast of the display of the physical object 110A and the physical environment 111. In another example, the notification can display options for obtaining information about the physical environment 111, e.g., the location of the physical environment, the size of a room, or any other information related to the physical environment 111. In another example, the notification can display options for obtaining files associated with the physical environment 111. Such embodiments can allow a computing device to obtain files that are stored in computing devices located in the physical environment 111. The computing device can obtain and share any set of files stored in association with the physical environment 111 in response to a user selecting a real-world object within the physical environment 111 or selecting the physical environment 111 itself. In yet another example, the notification can show that the system selected functionality for editing permissions for viewing the physical object. In such an example, a user can set permissions for other remote users to receive a video stream of the physical object 110A and the physical environment 111.

As shown in FIG. 6C, in response to a selection of a particular function, the computing device receiving the input can provide control data 181 to a server 1102 and the server can distribute data defining display properties or permission data 184 to other computing devices to perform the selected function or utilize the permission data.

In one illustrative example, one of the available functions specific to a physical object allows a user to control permissions with respect to the physical object. The user can use a voice command to grant a user, or specific groups of users, permissions to change a display setting with respect to the virtual object or edit a display property of a rendering of the physical object. In such an embodiment, control data 181 provided to a server 1102 can cause the server to issue permission data 183 to respective computing devices. The voice command or other gestures, such as a gaze gesture directed to a function displayed in the notification, can be used to grant specific permissions for specific user(s) to control a view of a physical object. For instance, the second user 104B (shown in FIG. 1) of the second computing device 101B can issue the command “Grant User X permissions to change the orientation of a view of a virtual object.” In response to such command, the system 100 can identify a computing device associated with User X and cause the server 1102 to communicate permission data 183 to a computing device associated with User X. In this example, User X can then edit their view of the physical object, such as rotate or scale the view.

Also shown in FIG. 6B, the system may display a function that allows a user to adjust the display of the physical object for a particular individual or a group of individuals. In this example, a user can issue a voice command to change a display property with respect to their own view or the views of other individuals, such as the participants of a communication session. For example, the user can issue a voice command indicating they want to increase the brightness or the scale of the rendering of the physical object. The user can also provide a voice command identifying an individual or a group of individuals that should receive the updated display properties.

In addition to the selection of an individual or a group of individuals to have display properties and/or permissions by the use of a voice command or another user input, the system can also select an individual or a group of users based on their roles within an organization. For instance, an individual may be selected to receive data, receive an updated view of an object, or receive permissions for editing attributes of an object, based on their title, their association with an organization, their participation within a communication session, or other data defining a role or responsibility with respect to that individual. Thus, in the examples shown in FIG. 6B and FIG. 5B and other examples described herein, the user can indicate a wish to adjust a display property and based on the roles of each participant of a communication session, the system can automatically change display properties or user-interface layouts of particular individuals having a role or responsibility that meets criteria. Criteria can be indicated in a user input such as a voice command, or the criteria can be defined in a preference file, a user profile, etc. For instance, if a meeting organizer modifies an arrangement of user interface arrangement using a gaze gesture, the system may then automatically change the user interface arrangement for all other meeting attendees. However, if a meeting attendee modifies an arrangement of user interface arrangement using one or more input controls such as a gaze gesture, the system may not modify user interface arrangements for other meeting attendees.

In yet another example, if a meeting attendee modifies an arrangement of user interface arrangement using one or more input controls such as a gaze gesture, the system may then automatically change the user interface arrangement for other meeting attendees that meet criteria of a policy. For instance, a policy may cause a system to automatically change the user interface arrangement for other meeting attendees that report to the attendee according to an organizational chart. In another example, a policy may cause a system to automatically change the user interface arrangement for other attendees that have permissions for accessing the shared content. If other attendees have permissions for accessing shared content, such as a file, the system may automatically change the user interface arrangement according to the one or more input controls for those attendees having permissions for accessing the shared content.

Similar features can also be provided to presenters and organizers of a meeting. If a presenter or an organizer modifies an arrangement of user interface arrangement using one or more input controls such as a gaze gesture, the system may then automatically change the user interface arrangement for other meeting attendees that meet criteria of a policy. For instance, a policy may indicate that a system can automatically change the user interface arrangement according to the input controls for designated meeting attendees that have permissions to access the shared content. Thus, user interface arrangements for attendees that do not have access permissions for the shared content can remain fixed and do not change in response to the user input controls.

The attendees receiving updated user interface arrangements according to the input controls may be filtered based on an attendee's title, role within an organization, ranking within an organization, etc. This filter can be used in combination with the permissions. Thus, in some configurations, the system can automatically change the user interface arrangement for attendees having a predetermined role and having permissions to access the shared content. If an attendee does not have the predetermined role or the attendee does not have permissions to access all of the shared content, the system does not change the user interface arrangement in response to the user input controls.

In general, user interface models interaction model having a particular user interface layout and/or select UI controls can be based on roles, permissions or a combination of the roles and permission. For example, a role within an organization, such as a manager of a team, can be assigned to receive a first of interaction model having a particular user interface layout and/or select UI controls, such as an interaction model that is configured by the use of an input control such as a gaze gesture. At the same time, executives of the same team can be assigned to receive another interaction model having another layout and/or select UI controls, such as a default interaction model. Such arrangements can apply to different roles within a communication session, such as an attendee, organizer, presenter, etc. For example, attendees can receive one interaction model, which can be based on an input control, such as a gaze gesture, and organizers and/or presenters can receive another interaction model, such as default or custom interaction model based on their role.

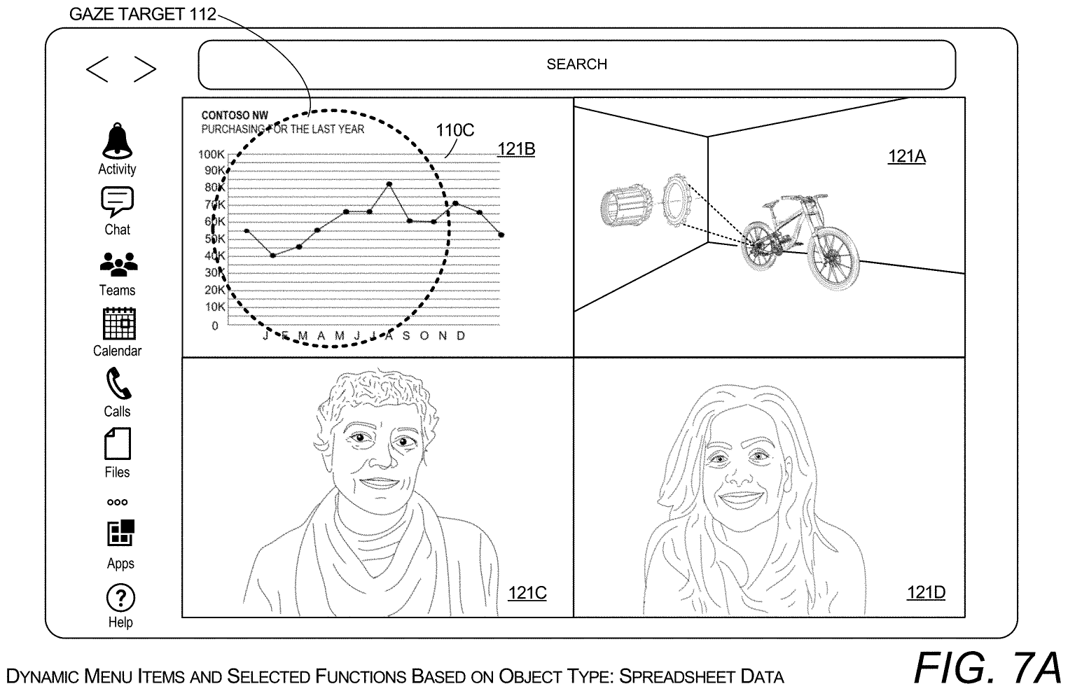

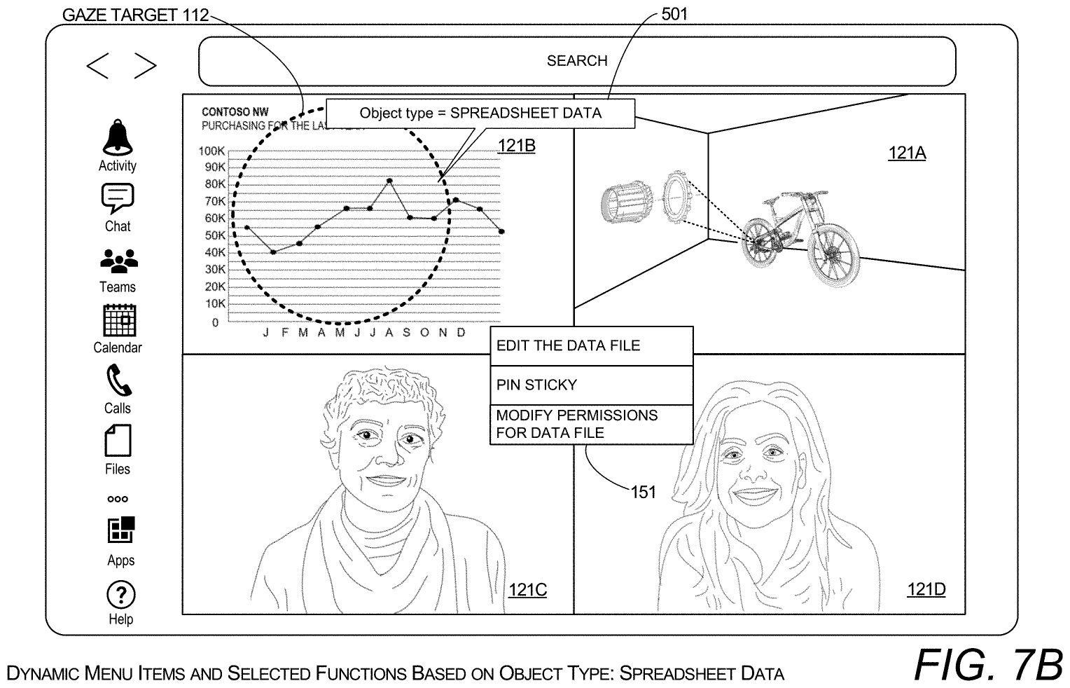

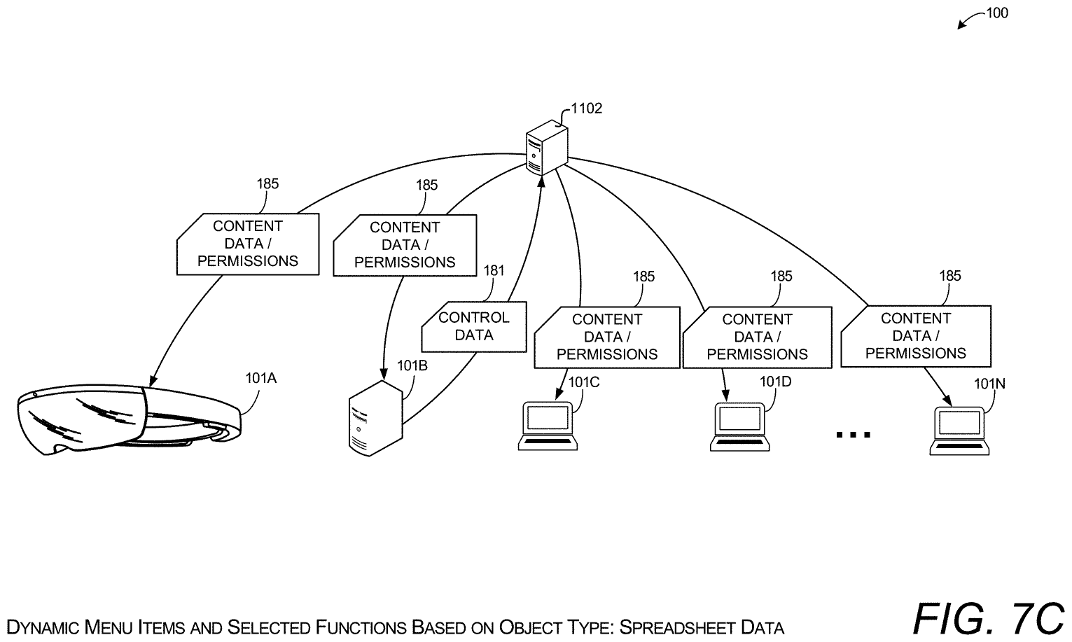

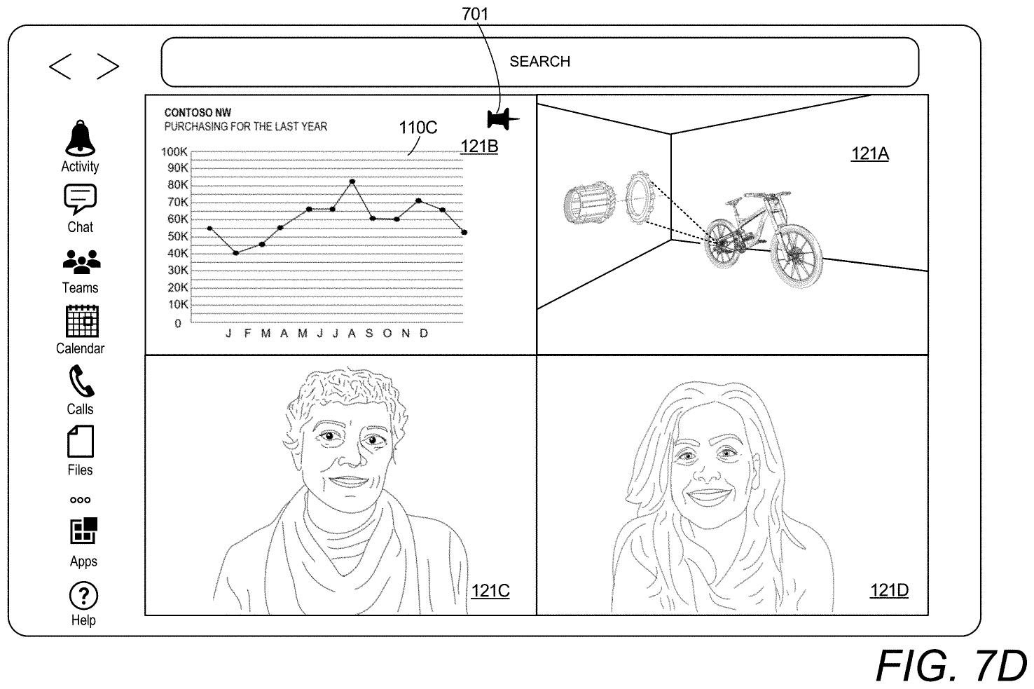

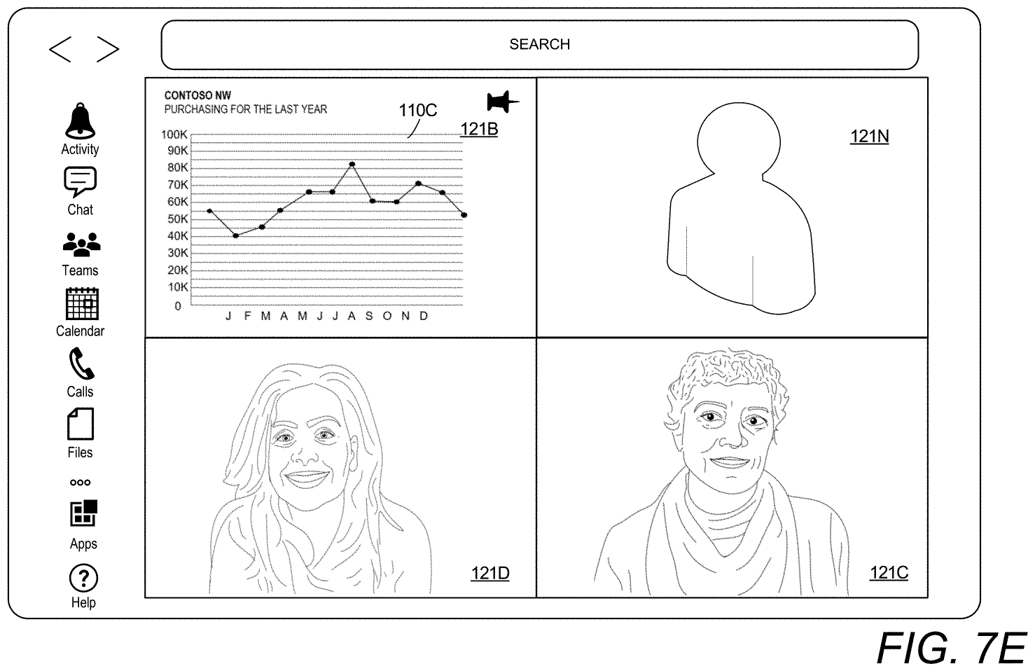

FIGS. 7A-7C illustrate an example scenario where a user selects an object that is a content object and the system selects a set of functions that is based on the object type. In FIG. 7A, the second display area 121B includes a view of a content object 110C. In this example, the user performs a gaze gesture that positions a gaze target 112 over a portion of the content object 110C. As shown in FIG. 7B, in response to determining that the object type is a content object, the system generates and displays a notification 151 describing object type and a set of functionality specific to the object type. In addition, the system can generate a graphical element 501 for providing notice of the object type. The notification 151 can provide a number of different options a user can select for performing the available functions. Functions may be selected by an interaction with the notification 151 or by another type of input such as a voice input or another type of input gesture. As shown in FIG. 7C, in response to a selection of a particular function, the computing device receiving the input can provide control data 181 to a server 1102 and the server can distribute data defining the content object or permission data 185 to other computing devices that are to use the content object or utilize the permission data.

In one illustrative example, one of the available functions specific to a content object allows a user to control permissions with respect to the content object. The user can use a voice command to grant a user, or specific groups of users, permissions to change the content data defining the content object. By changing permissions for specific individuals, those specific individuals may be granted permissions to change the underlying data of the content object that is displayed for all users of a communication session. In another example, one available function specific to the content object may allow a user to provide a voice command to specifically edit the content data. For example, the second user 104B (shown in FIG. 1) of the second computing device 101B can issue the command “change the chart type from a line graph to a bar graph.” In response to such command, the system 100 can directly modify the content of the file that the user is viewing by using a gaze gesture and/or a voice command.

In other examples, the system may display a function that allows a user to adjust the display of the content object for a particular individual or a group of individuals. In the example shown in FIG. 7B, a user can issue a voice command to “pin” the content object to a user interface. In this particular example, the function that is made available based on the object type includes a “pin sticky” function. As summarized above, such a function can cause the system to lock one or more display properties of a particular object that is selected using a gaze gesture. One example of this function is shown in FIGS. 7D and 7E.

As shown in FIG. 7D, once a particular object is selected for a pin sticky function, the system may cause the display of a graphical element 701 indicating that a particular object is selected. Thus, when the user interface 103 is modified by the use of other functionality, that particular object that is selected for a pin sticky function remains locked with respect to at least one display property. For example, the system may control a size and/or position of the pinned object while the user interface undergoes other changes based on user activity. In one specific example, the system may maintain a size and/or a position of the pinned object within a user interface. The size and/or position may be maintained with a defined threshold level. Thus, an object that is selected for the application of a pin sticky function may be repositioned or resized within a threshold level. One of the benefits of the pin sticky function is to allow users to maintain focus on a particular object by minimizing the amount of movement of the object regardless of the other functions that are applied to the user interface.

When a pin sticky function is performed, the other objects that are not pinned can be rearranged according to a level of activity with respect to each object. For example, in the transition shown between FIGS. 7D and 7E, a particular participant of a communication session, e.g., User N (104N of FIG. 1), may be promoted to be displayed within the user interface 103 based on a level of activity. A level of activity may be based on a level of activity of an audio channel associated with the user, or other activity such as a hand gesture, shared content, etc. In such an embodiment, although a number of objects made be rearranged based on a level of activity associated with each object, the pinned object, which in this case is the content object 110C, remains fixed with respect to the size and location of the rendering of the object within the user interface.

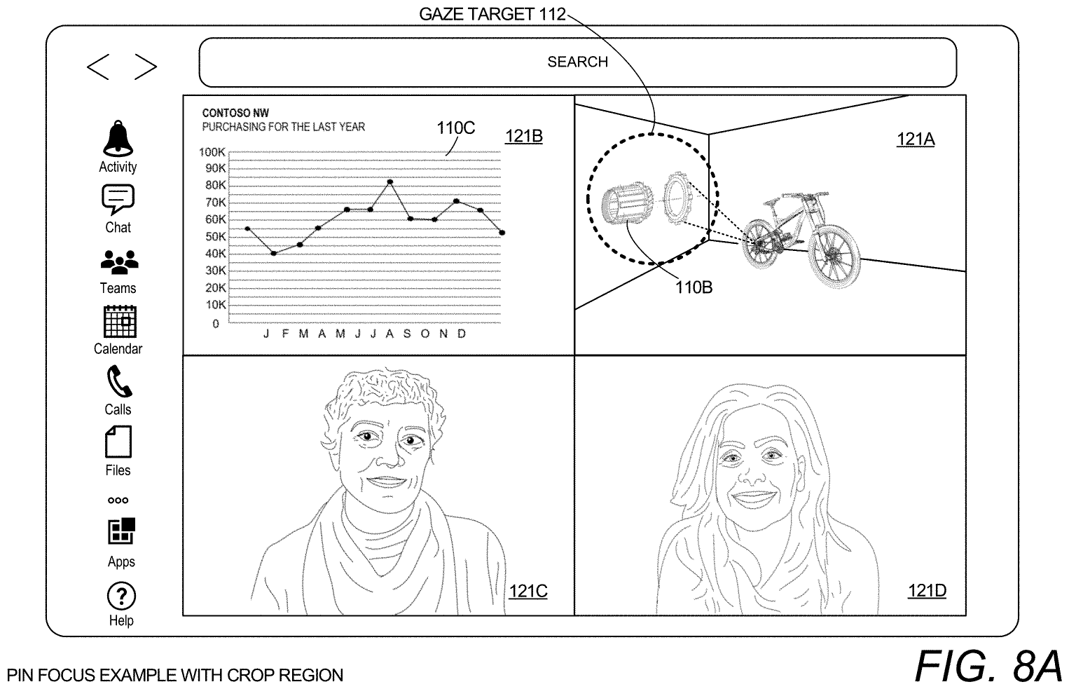

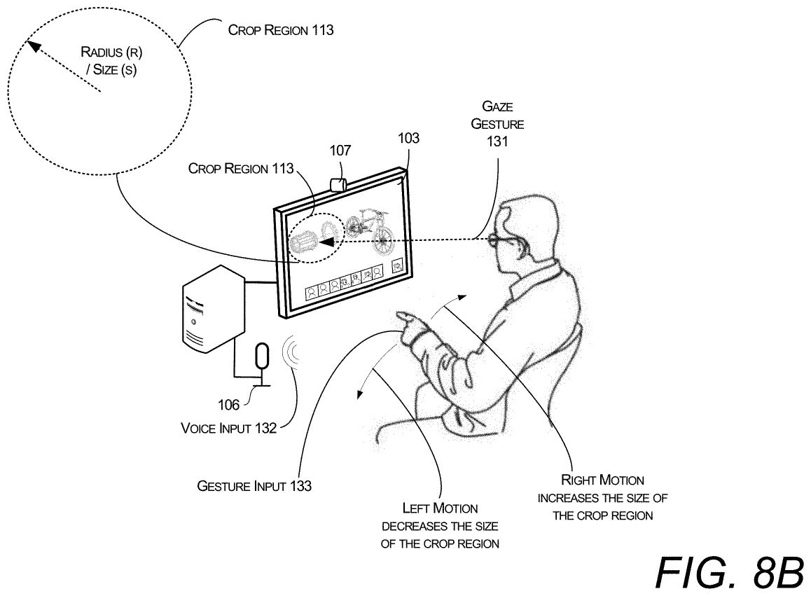

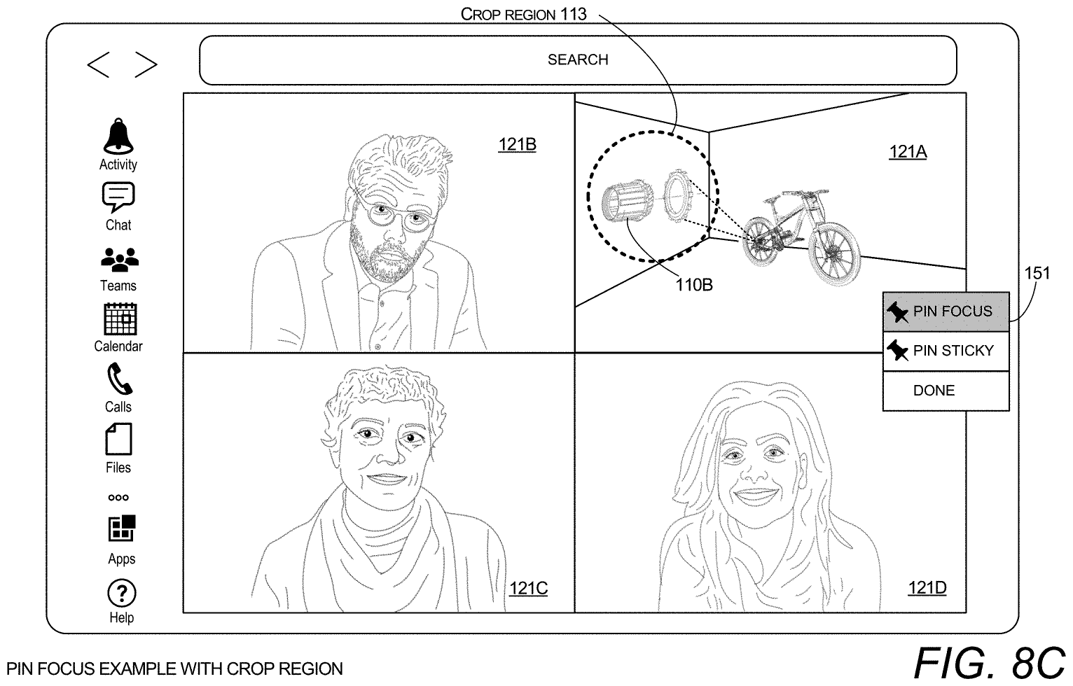

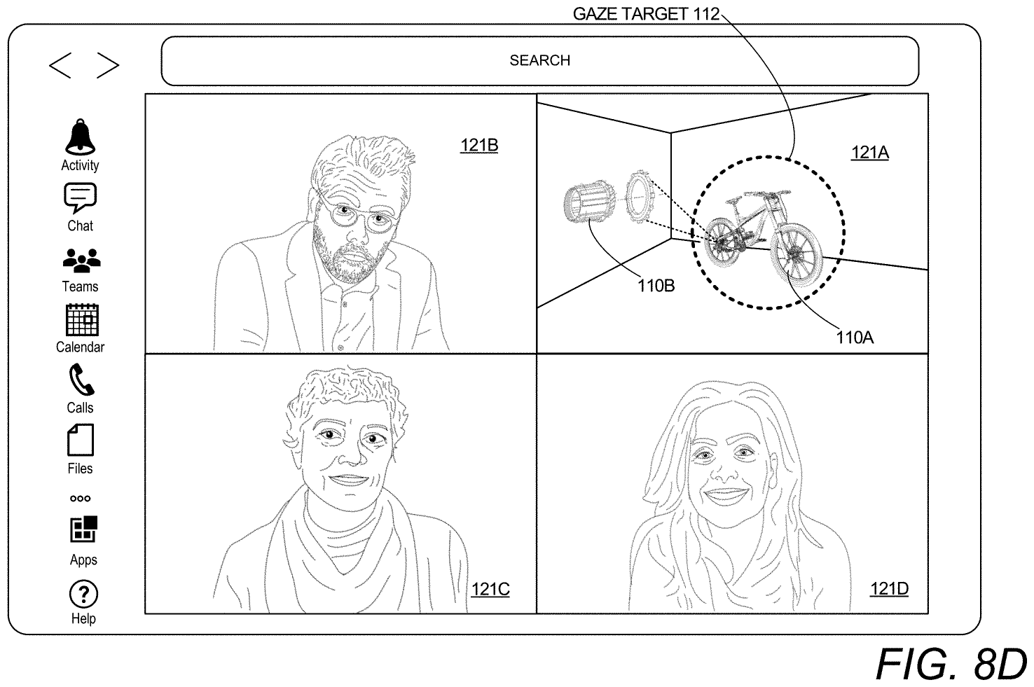

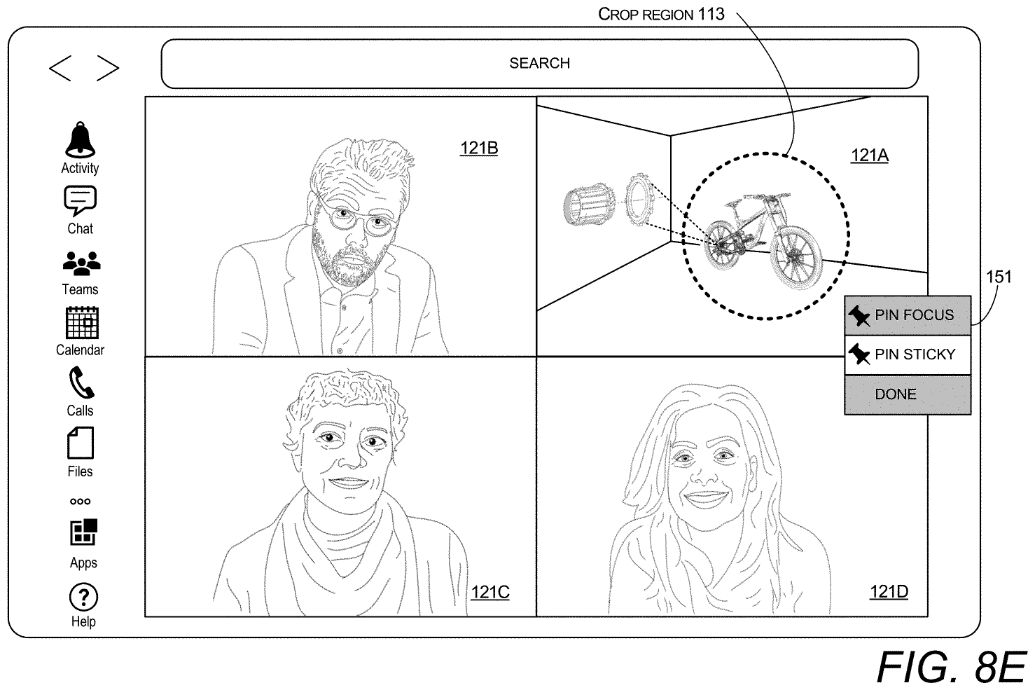

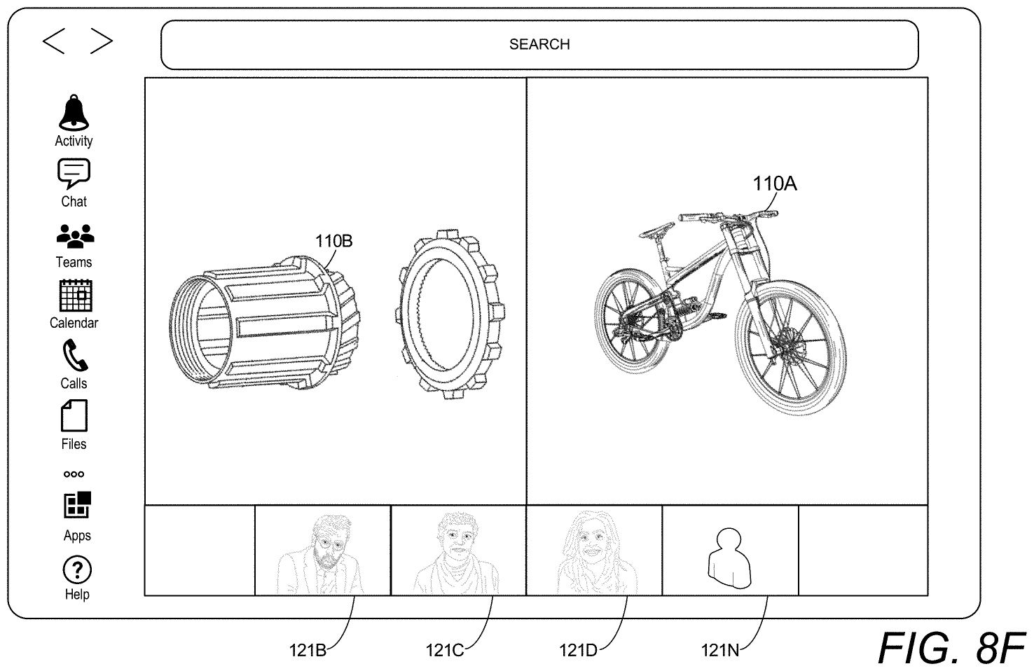

As summarized herein, the system can control a level of focus of a particular object rendered in a user interface by analyzing a user's gaze gesture with other forms of a user input. Thus, when the user is paying particular attention to an object within a user interface, a system can change a scale or zoom level of a rendering of that object. The system can control a level of detail that is displayed based on the user's gaze direction and other gestures. In some configurations, a crop region can be detected by the analysis of a user's gaze gesture and/or one or more voice or hand gestures. An example showing this feature is shown in FIGS. 8A through 8F.

FIG. 8A illustrates an example user interface where a user has selected a virtual object 110B by the use of a gaze gesture. As shown in FIG. 8B, the user also provides a supplemental gesture input 133 to control the size of a crop region 113. In this example, as the user moves his hand to the right, the size of the crop region can be increased. In addition, as the user moves his hand to the left, the size of the crop region can be decreased. This example is provided for illustrative purposes and is not to be construed as limiting. It can be appreciated that other hand gestures or other types of gestures such as voice commands can be used to increase or decrease the size of a crop region. It can be appreciated that the crop region can also be in other shapes such as squares, rectangles, ovals, or other shapes. The shape of a crop region can also be selected based on a type of object. For instance, an oval can be selected for virtual objects while a circle may be selected for real-world objects.

Once the size of a crop region is determined, as shown in FIG. 8C, the system may provide a notification 151 prompting a user to select a particular function associated with the crop region. In an example shown in FIG. 8C, the user selects a pin focus function with respect to the selected object, e.g., the virtual object 110B. Other objects can be selected using the operations described above. In an example shown in FIG. 8D, the user selects a second object 110A. Then in FIG. 8E, the user selects a crop region 113 for the selected object selects the pin focus function for the second object and then subsequently provides an input to cause the system to perform the selected functions.

FIG. 8F illustrates a reconfigured user interface 103 that is generated based on the execution of the selected functions. In this example, the rendering of the first selected object, the virtual object 110B, is enlarged and repositioned to a centralized location of the user interface. In addition, the rendering of the second selected object, the physical object 110A, is enlarged and repositioned to a centralized location of the user interface. In this example, the rendering of other objects that were not selected by the gaze gesture are rendered at a reduced size and also positioned in a non-centralized location, such as the bottom border of the user interface.

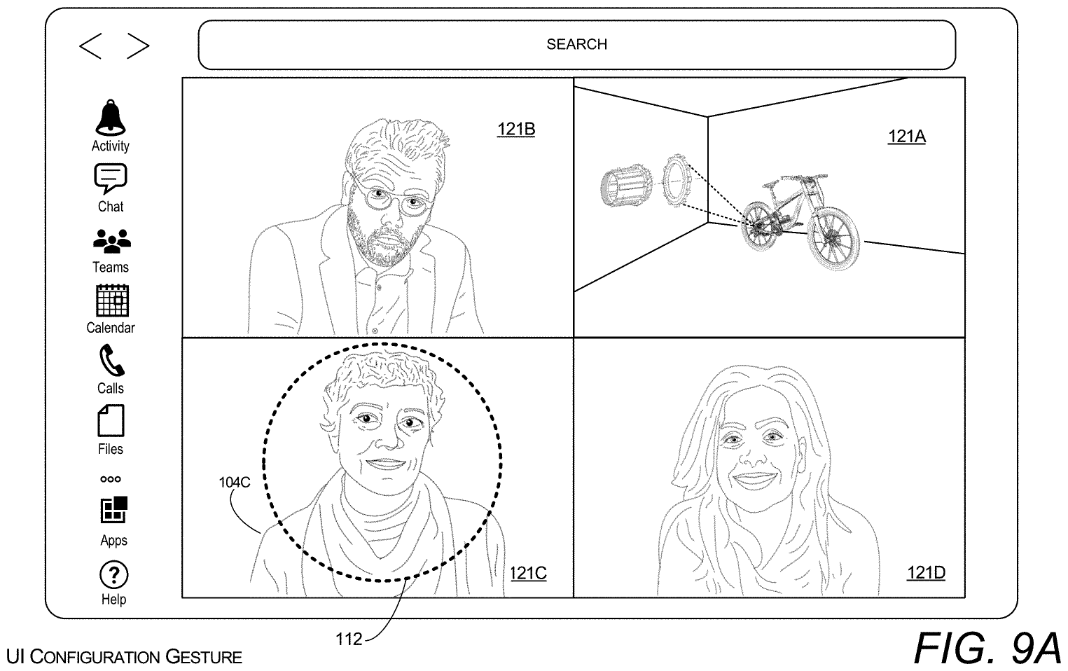

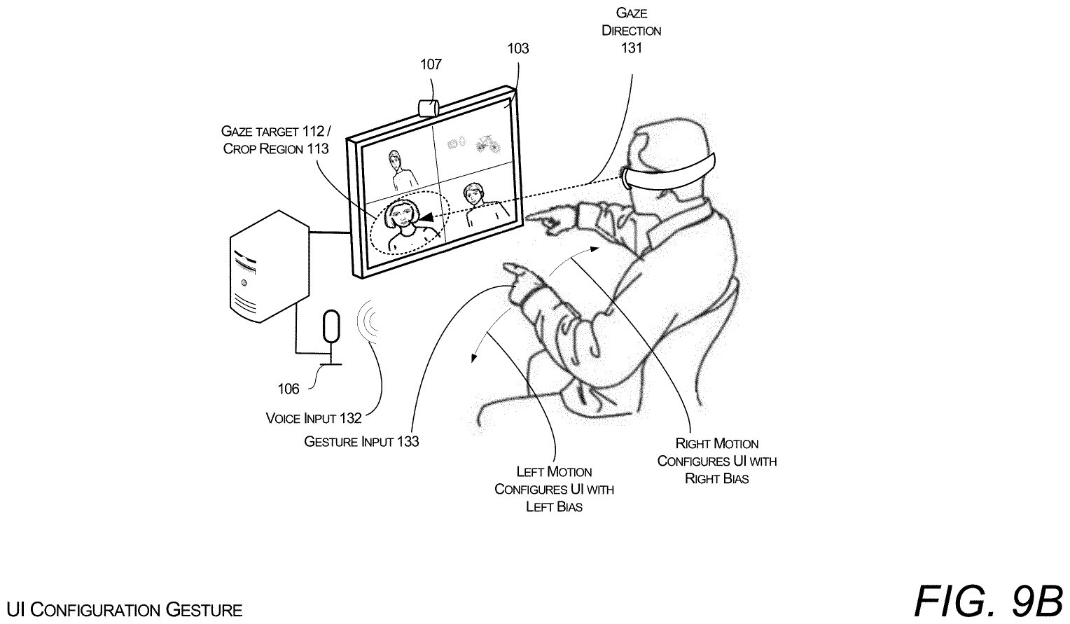

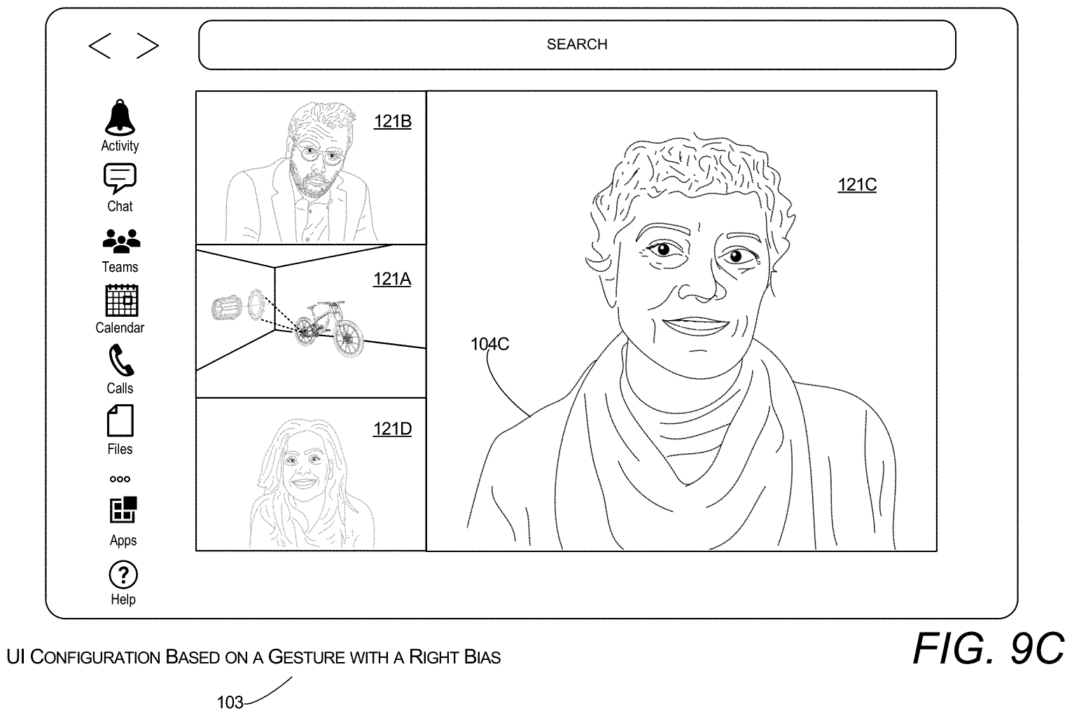

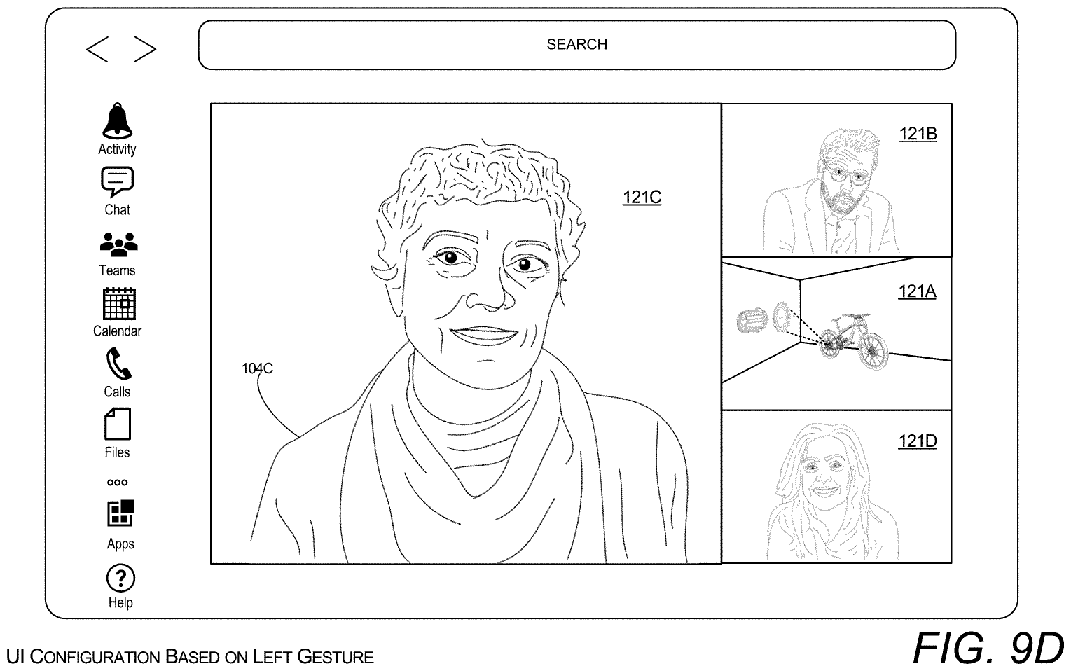

In some configurations, a user interface can be reconfigured based on a combination of gestures. For instance, a gaze gesture can be used to select one or more objects displayed within a user interface and a supplemental input, such as a hand gesture or a voice input, can be used to determine a position of a rendering for each object. FIGS. 9A through 9D illustrate examples of this feature.

In the example shown in FIG. 9A, a gaze gesture is utilized to determine a gaze target 112 for the purposes of selecting an object, such as the third user 104C. In conjunction with the selection of the object, as shown in FIG. 9B, the user can provide a supplemental input to indicate a direction. In this example, a hand gesture performed by the user can indicate a desire to configure a user interface with a right bias by moving his hand to the right or configure a user interface with a left bias by moving his hand to the left. This example is provided for illustrative purposes and is not to be construed as limiting. It can be appreciated that any gesture or voice input that indicates a direction can be used with the techniques disclosed herein.

FIG. 9C illustrates an example user interface 103 that is generated based on the selection of the object, the rendering of the third user 104C, and the supplemental gesture indicating a right bias. As shown, the rendering of the selected object is modified to bring focus to the third user 104C. The display area 121C is also positioned in a centralized or more prominent location that is influenced by the bias indicated by the supplemental input. In addition, the other objects that are not selected are moved to a location that accommodates the biased position of the selected object.

FIG. 9D illustrates an example user interface 103 that is generated based on the selection of the object, the rendering of the third user 104C, and the supplemental gesture indicating a left bias. As shown, the rendering of the selected object is modified to bring focus to the third user 104C. The display area 121C is also positioned in a centralized or more prominent location that is influenced by the bias indicated by the supplemental input. In addition, the other objects that are not selected are moved to a location that accommodates the biased position of the selected object.

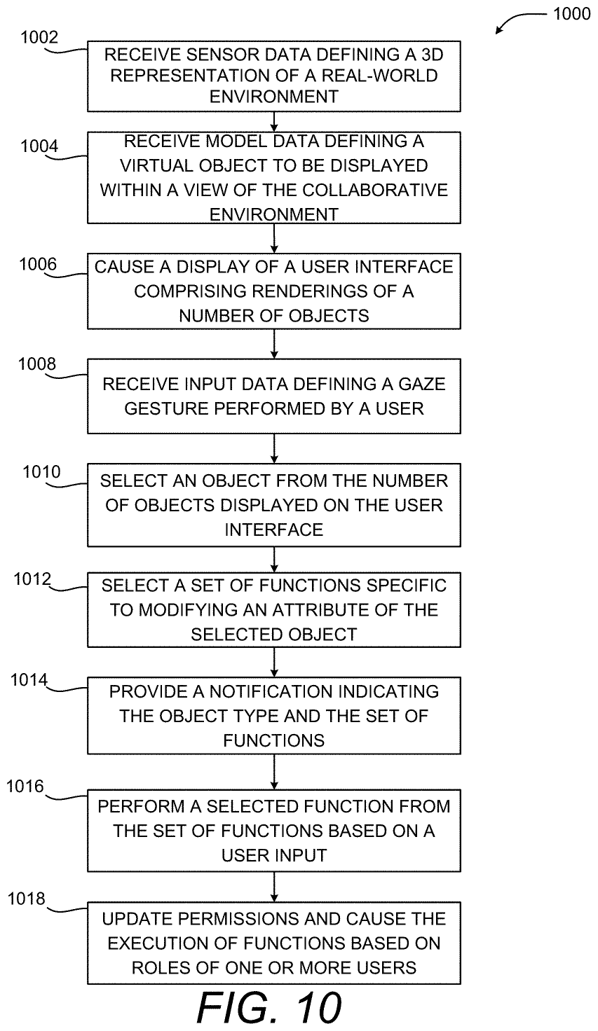

FIG. 10 is a diagram illustrating aspects of a routine 1000 for computationally efficient management of data associated with objects that are displayed within mixed-reality and virtual-reality collaboration environments. It should be understood by those of ordinary skill in the art that the operations of the methods disclosed herein are not necessarily presented in any particular order and that performance of some or all of the operations in an alternative order is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented: 1 as a sequence of computer implemented acts or program modules running on a computing system such as those described herein and/or 2 as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Additionally, the operations illustrated in FIG. 10 and the other FIGURES can be implemented in association with the example presentation UIs described above. For instance, the various devices and/or modules described herein can generate, transmit, receive, and/or display data associated with content of a communication session e.g., live content, broadcasted event, recorded content, etc. and/or a presentation UI that includes renderings of one or more participants of remote computing devices, avatars, channels, chat sessions, video streams, images, virtual objects, and/or applications associated with a communication session.

The routine 1000 begins at operation 1002, where the computing device receives sensor data that defines a 3D representation of a real-world environment. The sensor data can be captured by a depth map sensor, e.g., a depth map camera. In addition, the sensor data can be captured by an image sensor, e.g. a camera, where the depth map sensor and the image sensor can be part of the same component or in separate components. The sensor data comprises depth map data defining a three-dimensional model of a real-world environment and an image of the real-world environment. For instance, a real-world environment may include the walls of a room and a particular object within the room, such as the real-world object shown in FIG. 1. The sensor data can define physical properties of an object or a plurality of real-world objects within the real-world environment. The sensor data also indicates a geographic position of one or more objects within an environment. Thus, measurements of an object or measurements of the environment can be made by an analysis of the sensor data. One or more objects defined in the sensor data are shared with the number of users participating in a collaborative environment. The collaborative environment can include a communication session that allows users to send, receive and view aspects of the sensor data rendered on a display device.

The routine then proceeds to operation 1004, where the computing device 101 receives model data defining one or more virtual objects to be displayed within a view of the collaborative environment. The model data can define specific positions where the virtual objects are to be placed within a user interface of the collaborative environment.

At operation 1006, the computing device can cause a display of a user interface comprising renderings of a number of objects. For example, as shown in FIG. 2A, a user interface 103 can comprise a number of display areas 121A through 121D comprising renderings of different types of objects such as virtual objects, real-world objects, and content objects. The content objects can include renderings of productivity documents such as a word processing document, a spreadsheet document, a presentation document, etc.

Next, at operation 1008, the computing device can receive an input defining a gaze gesture performed by a user. As shown in FIG. 1, the user can look at a particular object displayed on a user interface. By the use of a camera or other type of sensor, the computing device can track the eye movement of the user to determine a gaze target within the user interface.

Next, at operation 1010, the computing device can select an object from the number of objects displayed on the user interface. In some configurations, a particular object is selected from the number of objects in response to determining that the gaze target meets one or more criteria with respect to the object. The criteria can be time-based, where a particular object is selected when the gaze target has a threshold level of overlap with a particular object for a predetermined period of time. The criteria can also be command based, where a particular object is selected when the gaze target has a threshold level of overlap with the particular object and the user issues another input, such as a voice command or a hand gesture.

Next, at operation 1012, the computing device can select a set of functions specific to modifying an attribute of the selected object. An attribute of an object can define any aspect of an object, such as but not limited to display properties, permissions for accessing data defining the object, permissions for modifying data defining the object. The attribute of an object can also define a location address where the file is stored, a file type defining the object, a list of files associated with the object, etc. The selection of the set of functions can be based on an object type of the selected object. For instance, the selection of a real-world object, i.e., a physical object, can cause the computing device to select functions that can modify display properties of a rendering of the physical object.

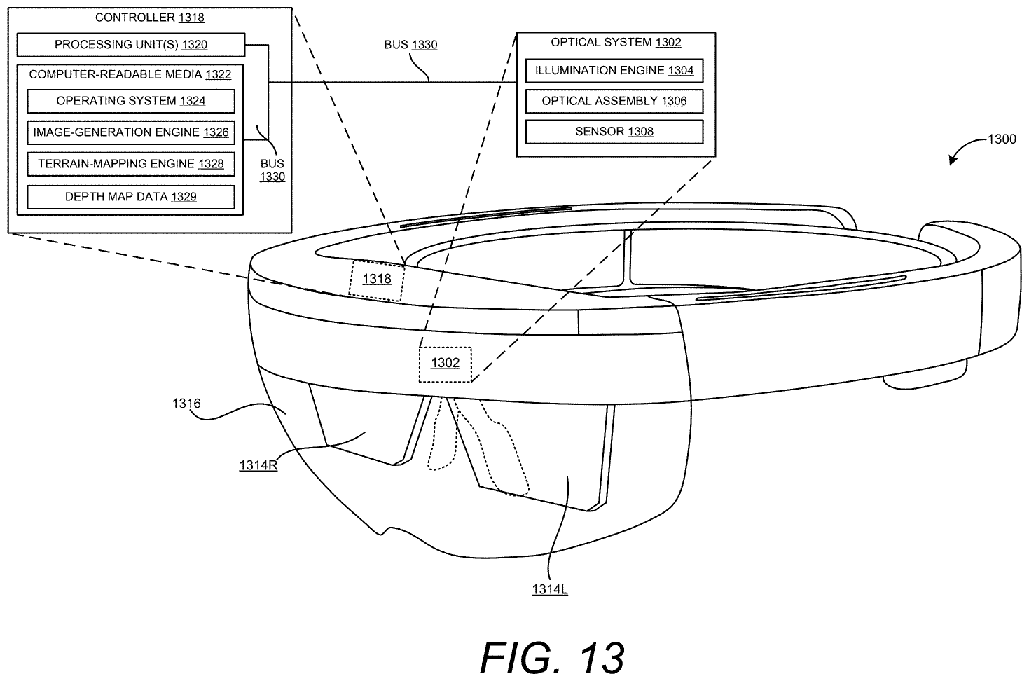

In some configurations, operation 1012 can involve a computing device that receives sensor data generated by a sensor 105, the sensor data comprising image data of a physical object 110A and depth map data 1329 (shown in FIG. 13) defining a model of the physical object 110A positioned within a physical environment 111. The physical object 110A can be one of the plurality of objects rendered in the user interface and selected by the gaze gesture. In addition, the set of functions are specific to modifying an attribute of the physical object. In some embodiments, the object type can be determined by the combination of data that is used to define the object. For instance, the system may determine that an object is a real-world object if the input data defining the object includes depth map data and/or image data. In some configurations, the set of functions comprises at least one of computer-executable instructions for modifying a display property of the sensor data to increase the prominence of the rendering of the physical object on the user interface, or computer-executable instructions for modifying permissions enabling one or more users to modify a display property of the physical object, wherein the permissions enable one or more users to adjust a zoom level, adjust a brightness level of the rendering of the physical object, or a contrast level of the rendering of the physical object.

In some configurations, operation 1012 can involve a computing device that receives model data defining a three-dimensional model of a virtual object 110B. The model data can define dimensions and textures of the virtual object, and the virtual object 110B can be one of the objects rendered in the user interface and selected by the gaze gesture. In such a scenario, the set of functions can be specific to modifying an attribute of the virtual object 110B. In some configurations, the set of functions can include at least one of (1) computer-executable instructions for modifying a display property of the model data to increase the prominence of the rendering of the virtual object on the user interface, or (2) computer-executable instructions for modifying permissions enabling one or more users to modify a display property of the virtual object, wherein the permissions enable one or more users to resize, rotate, or change textures of the virtual object.

In some configurations, operation 1012 can involve a computing device that receives content data defining a content object 110C. The content object 110C can be one of the plurality of objects rendered in the user interface and selected by the gaze gesture. The set of functions can be specific to modifying an attribute of the content object or specific to modifying the content itself. For instance, in response to a selection of a content object, such as a spreadsheet or a word processing document, using a gaze gesture, the system can select specific features for editing the spreadsheet data or text within the word processing document. In some configurations, the set of functions comprises at least one of (1) computer-executable instructions for modifying the content data, (2) computer-executable instructions for modifying a display property of the content data to increase the prominence of the rendering of the content object on the user interface, or (3) computer-executable instructions for modifying permissions enabling one or more users to modify the content data.

At operation 1014, the computing device can provide a notification indicating the object type and the set of functions. In some configurations, the notification can specifically list the detected object type. In some configurations, the system can also display the set of functions with the object type within a notification. The notification can be a graphical element displayed within a user interface or the notification can be another type of output such as an audio output describing the available functions. The notification can be in the form of a graphical element that is configured to receive a user selection of a particular function. In addition, or alternatively, the notification can display the available functions for the purposes of prompting the user to provide a voice command or other input gesture to select a function that may be applied to the object.

At operation 1016, the computing device can perform a selected function from the set of functions based on a user input. As summarized above, and also shown in FIGS. 5A through 7C, a selected function can be used to modify data defining an object, permissions associated with the object, display properties associated with the object, or other control data that can modify a display of a user interface at a particular remote computing device.

At operation 1018, the computing device can generate control data to update permissions or other data and cause the execution of functions based on the roles of one or more users. For instance, as shown in FIG. 7C, control data 181 can be communicated from the second computing device 101B to a server 1102 and/or other remote computing devices (101A, 101C, 101D up to 101N). The control data 181 can also include content data such as a spreadsheet file or a word processing file. Alternatively, the control data 181 can include instructions causing the server 1102 to distribute content data to one or more remote computing devices. Permissions can also be communicated to the remote reading devices for the purposes of allowing or restricting users of each remote computing device to manipulate a rendering of the content data. The permissions can also allow or restrict users of each remote computing device to edit the content data. A number of technical benefits can be provided by providing functionality that allows a person to share content and control permissions with use of an eye gaze gesture. In addition to the benefits described above, the features disclosed herein can reduce the need to have menus and other types of user interfaces to provide a comprehensive list of program features for every scenario. More targeted notifications or user interfaces without notifications or menus can be provided and users can interact with displayed objects by looking at an object.

It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more devices such as one or more internal or external CPUs or GPUs, and/or one or more pieces of hardware logic such as field-programmable gate arrays “FPGAs”, digital signal processors “DSPs”, or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

FIG. 11 is a diagram illustrating an example environment 1100 in which a system 1102 can implement aspects of the techniques disclosed herein. In some implementations, a system 1102 may function to collect, analyze, and share data defining one or more objects that are displayed to users of a communication session 1004.

As illustrated, the communication session 1104 may be implemented between a number of client computing devices 1106(1) through 1106(N) where N is a number having a value of two or greater that are associated with the system 1102 or are part of the system 1102. The client computing devices 1106(1) through 1106(N) enable users, also referred to as individuals, to participate in the communication session 1104. For instance, the first client computing device 1106(1) may be the computing device 101 of FIG. 1 or the computing device 1300 of FIG. 13. The computing devices 1106 are also referred to herein as a “data processing system 1106.”

In this example, the communication session 1104 is hosted, over one or more networks 1108, by the system 1102. That is, the system 1102 can provide a service that enables users of the client computing devices 1106(1) through 1106(N) to participate in the communication session 1104 e.g., via a live viewing and/or a recorded viewing. Consequently, a “participant” to the communication session 1104 can comprise a user and/or a client computing device e.g., multiple users may be in a room participating in a communication session via the use of a single client computing device, each of which can communicate with other participants. As an alternative, the communication session 1104 can be hosted by one of the client computing devices 1106(1) through 1106(N) utilizing peer-to-peer technologies. The system 1102 can also host chat conversations and other team collaboration functionality e.g., as part of an application suite.

In some implementations, such chat conversations and other team collaboration functionality are considered external communication sessions distinct from the communication session 1104. A computerized agent to collect participant data in the communication session 1104 may be able to link to such external communication sessions. Therefore, the computerized agent may receive information, such as date, time, session particulars, and the like, that enables connectivity to such external communication sessions. In one example, a chat conversation can be conducted in accordance with the communication session 1104. Additionally, the system 1102 may host the communication session 1104, which includes at least a plurality of participants co-located at a meeting location, such as a meeting room or auditorium, or located in disparate locations.

In examples described herein, client computing devices 1106(1) through 1106(N) participating in the communication session 1104 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera e.g., audio and visual data that capture the appearance and speech of a user participating in the communication session. In some implementations, the video feeds may comprise such audio and visual data, one or more still images, and/or one or more avatars. The one or more still images may also comprise one or more avatars. Any computing device can cause the display of a user interface on any other computing device by sending communication data. For illustrative purposes, causing the display of a user interface on a display device can include a local display device in communication with a computer executing a program embodying the techniques disclosed herein, or any other display device in communication with a remote computing device receiving communication data from the computer executing a program embodying the techniques disclosed herein.

Another example of an individual stream of live or recorded content can comprise media data that includes an avatar of a user participating in the communication session along with audio data that captures the speech of the user. Yet another example of an individual stream of live or recorded content can comprise media data that includes a file displayed on a display screen along with audio data that captures the speech of a user. Accordingly, the various streams of live or recorded content within the communication data enable a remote meeting to be facilitated between a group of people and the sharing of content within the group of people. In some implementations, the various streams of live or recorded content within the communication data may originate from a plurality of co-located video cameras, positioned in a space, such as a room, to record or stream live a presentation that includes one or more individuals presenting and one or more individuals consuming presented content.

A participant or attendee can view content of the communication session 1104 live as activity occurs, or alternatively, via a recording at a later time after the activity occurs. In examples described herein, client computing devices 1106(1) through 1106(N) participating in the communication session 1104 are configured to receive and render for display, on a user interface of a display screen, communication data. The communication data can comprise a collection of various instances, or streams, of live and/or recorded content. For example, an individual stream of content can comprise media data associated with a video feed e.g., audio and visual data that capture the appearance and speech of a user participating in the communication session. Another example of an individual stream of content can comprise media data that includes an avatar of a user participating in the conference session along with audio data that captures the speech of the user. Yet another example of an individual stream of content can comprise media data that includes a content item displayed on a display screen and/or audio data that captures the speech of a user. Accordingly, the various streams of content within the communication data enable a meeting or a broadcast presentation to be facilitated amongst a group of people dispersed across remote locations.

A participant or attendee to a communication session is a person that is in range of a camera, or other image and/or audio capture device such that actions and/or sounds of the person which are produced while the person is viewing and/or listening to the content being shared via the communication session can be captured e.g., recorded. For instance, a participant may be sitting in a crowd viewing the shared content live at a broadcast location where a stage presentation occurs. Or a participant may be sitting in an office conference room viewing the shared content of a communication session with other colleagues via a display screen. Even further, a participant may be sitting or standing in front of a personal device e.g., tablet, smartphone, computer, etc. viewing the shared content of a communication session alone in their office or at home.

The system 1102 includes devices 1110. The devices 1110 and/or other components of the system 1102 can include distributed computing resources that communicate with one another and/or with the client computing devices 1106(1) through 1106(N) via the one or more networks 1108. In some examples, the system 1102 may be an independent system that is tasked with managing aspects of one or more communication sessions such as communication session 1104. As an example, the system 1102 may be managed by entities such as SLACK, WEBEX, GOTOMEETING, GOOGLE HANGOUTS, etc.

Networks 1108 may include, for example, public networks such as the Internet, private networks such as an institutional and/or personal intranet, or some combination of private and public networks. Networks 1108 may also include any type of wired and/or wireless network, including but not limited to local area networks “LANs”, wide area networks “WANs”, satellite networks, cable networks, Wi-Fi networks, WiMax networks, mobile communications networks e.g., 3G, 4G, and so forth or any combination thereof. Networks 1108 may utilize communications protocols, including packet-based and/or datagram-based protocols such as Internet protocol “IP”, transmission control protocol “TCP”, user datagram protocol “UDP”, or other types of protocols. Moreover, networks 1108 may also include a number of devices that facilitate network communications and/or form a hardware basis for the networks, such as switches, routers, gateways, access points, firewalls, base stations, repeaters, backbone devices, and the like.

In some examples, networks 1108 may further include devices that enable connection to a wireless network, such as a wireless access point “WAP”. Examples support connectivity through WAPs that send and receive data over various electromagnetic frequencies e.g., radio frequencies, including WAPs that support Institute of Electrical and Electronics Engineers “IEEE” 802.11 standards e.g., 802.11g, 802.11n, 802.11ac and so forth, and other standards.

In various examples, devices 1110 may include one or more computing devices that operate in a cluster or other grouped configuration to share resources, balance load, increase performance, provide fail-over support or redundancy, or for other purposes. For instance, devices 1110 may belong to a variety of classes of devices such as traditional server-type devices, desktop computer-type devices, and/or mobile-type devices. Thus, although illustrated as a single type of device or a server-type device, devices 1110 may include a diverse variety of device types and are not limited to a particular type of device. Devices 1110 may represent, but are not limited to, server computers, desktop computers, web-server computers, personal computers, mobile computers, laptop computers, tablet computers, or any other sort of computing device.

A client computing device e.g., one of client computing devices 1106(1) through 1106(N) may belong to a variety of classes of devices, which may be the same as, or different from, devices 1110, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant “PDA”, a mobile phone/tablet hybrid, a laptop computer, a telecommunication device, a computer navigation type client computing device such as a satellite-based navigation system including a global positioning system “GPS” device, a wearable device, a virtual reality “VR” device, an augmented reality “AR” device, an implanted computing device, an automotive computer, a network-enabled television, a thin client, a terminal, an Internet of Things “IoT” device, a work station, a media player, a personal video recorder “PVR”, a set-top box, a camera, an integrated component e.g., a peripheral device for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing devices 1106(1) through 1106(N) which correlate to computing devices 101A-101N of FIG. 1 of the various classes and device types can represent any type of computing device having one or more data processing units 1192 operably connected to computer-readable media 1194 such as via a bus 1116, which in some instances can include one or more of a system bus, a data bus, an address bus, a PCI bus, a Mini-PCI bus, and any variety of local, peripheral, and/or independent buses.

Executable instructions stored on computer-readable media 1194 may include, for example, an operating system 1119, a client module 1120, a profile module 1122, and other modules, programs, or applications that are loadable and executable by data processing units 1192.

Client computing devices 1106(1) through 1106(N) may also include one or more interfaces 1124 to enable communications between client computing devices 1106(1) through 1106(N) and other networked devices, such as devices 1110, over networks 1108. Such network interfaces 1124 may include one or more network interface controllers NICs or other types of transceiver devices to send and receive communications and/or data over a network. Moreover, client computing devices 1106(1) through 1106(N) can include input/output “I/O” interface devices 1126 that enable communications with input/output devices such as user input devices including peripheral input devices e.g., a game controller, a keyboard, a mouse, a pen, a voice input device such as a microphone, a video camera for obtaining and providing video feeds and/or still images, a touch input device, a gestural input device, and the like and/or output devices including peripheral output devices e.g., a display, a printer, audio speakers, a haptic output device, and the like. FIG. 11 illustrates that client computing device 1106(1) is in some way connected to a display device e.g., a display screen 1129(1), which can display a UI according to the techniques described herein.

In the example environment 1100 of FIG. 11, client computing devices 1106(1) through 1106(N) may use their respective client modules 1120 to connect with one another and/or other external devices in order to participate in the communication session 1104, or in order to contribute activity to a collaboration environment. For instance, a first user may utilize a client computing device 1106(1) to communicate with a second user of another client computing device 1106(2). When executing client modules 1120, the users may share data, which may cause the client computing device 1106(1) to connect to the system 1102 and/or the other client computing devices 1106(2) through 1106(N) over the network(s) 1108.

The client computing devices 1106(1) through 1106(N) may use their respective profile modules 1122 to generate participant profiles within the profile module 1122 and provide the participant profiles to other client computing devices and/or to the devices 1110 of the system 1102. A participant profile may include one or more of an identity of a user or a group of users e.g., a name, a unique identifier “ID”, etc., user data such as personal data, machine data such as location e.g., an IP address, a room in a building, etc. and technical capabilities, etc. Participant profiles may be utilized to register participants for communication sessions.

As shown in FIG. 11, the devices 1110 of the system 1102 include a server module 1130 and an output module 1132. In this example, the server module 1130 is configured to receive, from individual client computing devices such as client computing devices 1106(1) through 1106(N), media streams 1134(1) through 1134(N). As described above, media streams can comprise a video feed e.g., audio and visual data associated with a user, audio data which is to be output with a presentation of an avatar of a user e.g., an audio only experience in which video data of the user is not transmitted, text data e.g., text messages, file data and/or screen sharing data e.g., a document, a slide deck, an image, a video displayed on a display screen, etc., and so forth. Thus, the server module 1130 is configured to receive a collection of various media streams 1134(1) through 1134(N) during a live viewing of the communication session 1104, the collection being referred to herein as “media data 1134”. In some scenarios, not all of the client computing devices that participate in the communication session 1104 provide a media stream. For example, a client computing device may only be a consuming, or a “listening”, device such that it only receives content associated with the communication session 1104 but does not provide any content to the communication session 1104. The media stream 1134 is also referred to herein as “input data 1134.” The input data 1134 can be generated at any computing device and used as an input on any computing device. The input data 1134 can define a number of different types of objects that can be rendered on a display device. For instance, the input data can define spreadsheet data, word processing document data, presentation data, image data, audio data, video data, and any other suitable format defining content. The input data can also define virtual reality objects which may be in two-dimensional or three-dimensional formats. The input data can also define three-dimensional models and image data that can be generated based on sensor data comprising image data of a physical object 110A and depth map data 1329 defining a model of the physical object 110A positioned within a physical environment 111, as shown in FIG. 1.

In various examples, the server module 1130 can select aspects of the media streams 1134 that are to be shared with individual ones of the participating client computing devices 1106(1) through 1106(N). Consequently, the server module 1130 may be configured to generate session data 1136 based on the streams 1134 and/or parse the session data 1136 to the output module 1132. Then, the output module 1132 may communicate communication data 1139 to the client computing devices e.g., client computing devices 1106(1) through 1106(3) participating in a live viewing of the communication session. The communication data 1139 may include video, audio, and/or other content data, provided by the output module 1132 based on content 1150 associated with the output module 1132 and based on received session data 1136.

As shown, the output module 1132 transmits communication data 1139(1) to client computing device 1106(1), and transmits communication data 1139(2) to client computing device 1106(2), and transmits communication data 1139(3) to client computing device 1106(3), etc. The communication data 1139 transmitted to the client computing devices can be the same or can be different e.g., positioning of streams of content within a user interface may vary from one device to the next.

In various implementations, the devices 1110 and/or the client module 1120 can include UI presentation module 1140. The UI presentation module 1140 may be configured to analyze communication data 1139 that is for delivery to one or more of the client computing devices 1106. Specifically, the UI presentation module 1140, at the devices 1110 and/or the client computing device 1106, may analyze communication data 1139 to determine an appropriate manner for displaying video, image, and/or content on the display screen 1129 of an associated client computing device 1106. In some implementations, the UI presentation module 1140 may provide video, image, and/or content to a presentation UI 1146 rendered on the display screen 1129 of the associated client computing device 1106. The presentation UI 1146 may be caused to be rendered on the display screen 1129 by the UI presentation module 1140. The presentation UI 1146 may include the video, image, and/or content analyzed by the UI presentation module 1140.

In some implementations, the presentation UI 1146 may include a plurality of sections or grids that may render or comprise video, image, and/or content for display on the display screen 1129. For example, a first section of the presentation UI 1146 may include a video feed of a presenter or individual, and a second section of the presentation UI 1146 may include a video feed of an individual consuming meeting information provided by the presenter or individual. The UI presentation module 1140 may populate the first and second sections of the presentation UI 1146 in a manner that properly imitates an environment experience that the presenter and the individual may be sharing.

In some implementations, the UI presentation module 1140 may enlarge or provide a zoomed view of the individual represented by the video feed in order to highlight a reaction, such as a facial feature, the individual had to the presenter. In some implementations, the presentation UI 1146 may include a video feed of a plurality of participants associated with a meeting, such as a general communication session. In other implementations, the presentation UI 1146 may be associated with a channel, such as a chat channel, enterprise teams channel, or the like. Therefore, the presentation UI 1146 may be associated with an external communication session that is different than the general communication session.

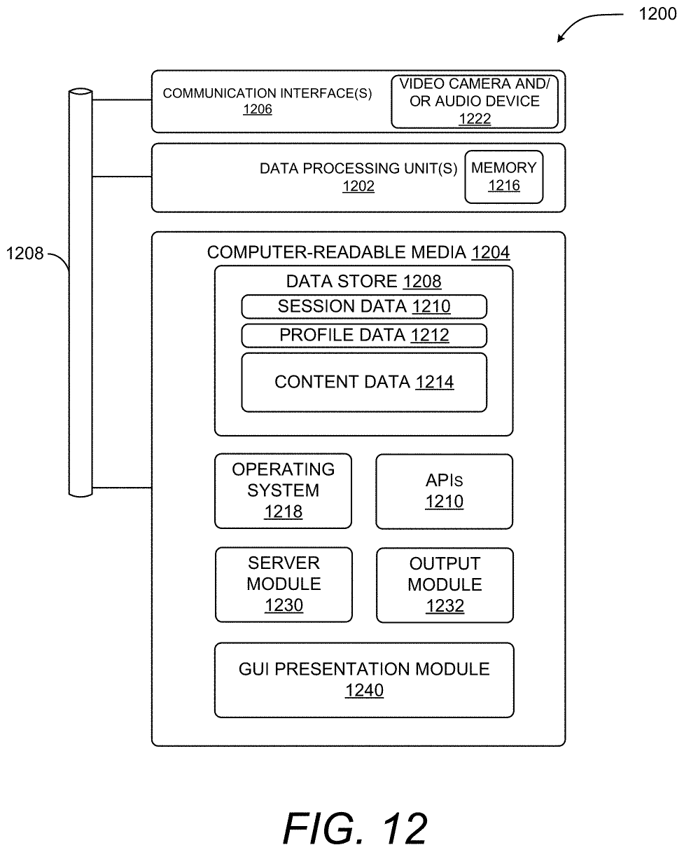

FIG. 12 illustrates a diagram that shows example components of an example device 1200 also referred to herein as a “computing device” configured to generate data for some of the user interfaces disclosed herein. The device 1200 may generate data that may include one or more sections that may render or comprise video, images, virtual objects, and/or content for display on the display screen 1129. The device 1200 may represent one of the devices described herein. Additionally, or alternatively, the device 1200 may represent one of the client computing devices 1106.

As illustrated, the device 1200 includes one or more data processing units 1202, computer-readable media 1204, and communication interfaces 1206. The components of the device 1200 are operatively connected, for example, via a bus 1208, which may include one or more of a system bus, a data bus, an address bus, a PCI bus, a Mini-PCI bus, and any variety of local, peripheral, and/or independent buses.

As utilized herein, data processing units, such as the data processing units 1202 and/or data processing units 1192, may represent, for example, a CPU-type data processing unit, a GPU-type data processing unit, a field-programmable gate array “FPGA”, another class of DSP, or other hardware logic components that may, in some instances, be driven by a CPU. For example, and without limitation, illustrative types of hardware logic components that may be utilized include Application-Specific Integrated Circuits “ASICs”, Application-Specific Standard Products “ASSPs”, System-on-a-Chip Systems “SOCs”, Complex Programmable Logic Devices “CPLDs”, etc.

As utilized herein, computer-readable media, such as computer-readable media 1204 and computer-readable media 1194, may store instructions executable by the data processing units. The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory “RAM”, static random-access memory “SRAM”, dynamic random-access memory “DRAM”, phase change memory “PCM”, read-only memory “ROM”, erasable programmable read-only memory “EPROM”, electrically erasable programmable read-only memory “EEPROM”, flash memory, compact disc read-only memory “CD-ROM”, digital versatile disks “DVDs”, optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interfaces 1206 may represent, for example, network interface controllers “NICs” or other types of transceiver devices to send and receive communications over a network. Furthermore, the communication interfaces 1206 may include one or more video cameras and/or audio devices 1222 to enable generation of video feeds and/or still images, and so forth.

In the illustrated example, computer-readable media 1204 includes a data store 1208. In some examples, the data store 1208 includes data storage such as a database, data warehouse, or other type of structured or unstructured data storage. In some examples, the data store 1208 includes a corpus and/or a relational database with one or more tables, indices, stored procedures, and so forth to enable data access including one or more of hypertext markup language “HTML” tables, resource description framework “RDF” tables, web ontology language “OWL” tables, and/or extensible markup language “XML” tables, for example.

The data store 1208 may store data for the operations of processes, applications, components, and/or modules stored in computer-readable media 1204 and/or executed by data processing units 1202 and/or accelerators. For instance, in some examples, the data store 1208 may store session data 1210 e.g., session data 1136, profile data 1212 e.g., associated with a participant profile, and/or other data. The session data 1210 can include a total number of participants e.g., users and/or client computing devices in a communication session, activity that occurs in the communication session, a list of invitees to the communication session, and/or other data related to when and how the communication session is conducted or hosted. The data store 1208 may also include content data 1214, such as the content that includes video, audio, or other content for rendering and display on one or more of the display screens 1129.

Alternately, some or all of the above-referenced data can be stored on separate memories 1216 on board one or more data processing units 1202 such as a memory on board a CPU-type processor, a GPU-type processor, an FPGA-type accelerator, a DSP-type accelerator, and/or another accelerator. In this example, the computer-readable media 1204 also includes an operating system 1218 and application programming interfaces (APIs) 1210 configured to expose the functionality and the data of the device 1200 to other devices. Additionally, the computer-readable media 1204 includes one or more modules such as the server module 1230, the output module 1232, and the GUI presentation module 1240, although the number of illustrated modules is just an example, and the number may vary higher or lower. That is, functionality described herein in association with the illustrated modules may be performed by a fewer number of modules or a larger number of modules on one device or spread across multiple devices.

FIG. 13 is a computing device diagram showing aspects of the configuration and operation of a computing device 1300 that can implement aspects of the systems disclosed herein. The computing device 1300 shows details of one of the computing devices 101 shown in FIG. 1. The computing device 1300 can provide augmented reality “AR” environments or virtual reality “VR” environments. Generally described, AR environments superimpose computer-generated “CG” images over a user's view of a real-world environment. For example, a computing device 1300 can generate composite views to enable a user to visually perceive a computer-generated image superimposed over a rendering of a real-world environment 111, wherein the rendering of the real-world environment 111 is created by a camera 105 directed to the real-world environment, such as a room. In some embodiments, a computing device 1300 can generate composite views to enable a user to visually perceive a computer-generated image superimposed over a direct view of a real-world environment 111. Thus, the computing device 1300 may have a prism or other optical device that allows a user to see through the optical device to see a direct view of a real-world object or a real-world environment, and at the same time, a computer-generated image superimposed over that view of the real-world object. An AR environment can also be referred to herein as a mixed reality “MR” environment. An MR device can provide both AR and VR environments. A VR environment includes computer-generated images of a virtual environment and virtual objects. MR and AR environments can utilize depth map sensors to determine a distance between the device and a real-world object. This allows the computer to scale and position a computer-generated graphic over a real-world object in a realistic manner.

In the example shown in FIG. 13, an optical system 1302 includes an illumination engine 1304 to generate electromagnetic “EM” radiation that includes both a first bandwidth for generating CG images and a second bandwidth for tracking physical objects. The first bandwidth may include some or all of the visible-light portion of the EM spectrum whereas the second bandwidth may include any portion of the EM spectrum that is suitable to deploy a desired tracking protocol. In this example, the optical system 1302 further includes an optical assembly 1306 that is positioned to receive the EM radiation from the illumination engine 1304 and to direct the EM radiation or individual bandwidths thereof along one or more predetermined optical paths.

For example, the illumination engine 1304 may emit the EM radiation into the optical assembly 1306 along a common optical path that is shared by both the first bandwidth and the second bandwidth. The optical assembly 1306 may also include one or more optical components that are configured to separate the first bandwidth from the second bandwidth e.g., by causing the first and second bandwidths to propagate along different image-generation and object-tracking optical paths, respectively.

In some instances, a user experience is dependent on the computing device 1300 accurately identifying characteristics of a physical object (a “real-world object 110”) or a plane, such as the real-world floor, and then generating the CG image in accordance with these identified characteristics. For example, suppose that the computing device 1300 is programmed to generate a user perception that a virtual gaming character is running towards and ultimately jumping over a real-world structure. To achieve this user perception, the computing device 1300 might obtain detailed data defining features of the real-world environment 111 around the computing device 1300. In order to provide this functionality, the optical system 1302 of the computing device 1300 might include a laser line projector and a differential imaging camera (both not shown in FIG. 13) in some embodiments.

In some examples, the computing device 1300 utilizes an optical system 1302 to generate a composite view e.g., from a perspective of a user that is wearing the computing device 1300 that includes both one or more CG images and a view of at least a portion of the real-world environment 111. For example, the optical system 1302 might utilize various technologies such as, for example, AR technologies, to generate composite views that include CG images superimposed over a real-world view. As such, the optical system 1302 might be configured to generate CG images via an optical assembly 1306 that includes a display panel 1314.

In the illustrated example, the display panel includes separate right eye and left eye transparent display panels, labeled 1314R and 1314L, respectively. In some examples, the display panel 1314 includes a single transparent display panel that is viewable with both eyes or a single transparent display panel that is viewable by a single eye only. Therefore, it can be appreciated that the techniques described herein might be deployed within a single-eye device e.g. the GOOGLE GLASS AR device and within a dual-eye device e.g. the MICROSOFT HOLOLENS AR device.

Light received from the real-world environment 111 passes through the see-through display panel 1314 to the eye or eyes of the user. Graphical content computed by an image-generation engine 1326 executing on the processing units 1320 and displayed by right-eye and left-eye display panels, if configured as see-through display panels, might be used to visually augment or otherwise modify the real-world environment 111 viewed by the user through the see-through display panels 1314. In this configuration, the user is able to view virtual objects that do not exist within the real-world environment 111 at the same time that the user views physical objects 110 within the real-world environment 111. This creates an illusion or appearance that the virtual objects 104 are physical objects 110 or physically present light-based effects located within the real-world environment 111.

In some examples, the display panel 1314 is a waveguide display that includes one or more diffractive optical elements “DOEs” for in-coupling incident light into the waveguide, expanding the incident light in one or more directions for exit pupil expansion, and/or out-coupling the incident light out of the waveguide e.g., toward a user's eye. In some examples, the computing device 1300 further includes an additional see-through optical component, shown in FIG. 13 in the form of a transparent veil 1316 positioned between the real-world environment 111 and the display panel 1314. It can be appreciated that the transparent veil 1316 might be included in the computing device 1300 for purely aesthetic and/or protective purposes.

The computing device 1300 might further include various other components not all of which are shown in FIG. 13, for example, front-facing cameras e.g. red/green/blue “RGB”, black & white “B&W”, or infrared “IR” cameras, speakers, microphones, accelerometers, gyroscopes, magnetometers, temperature sensors, touch sensors, biometric sensors, other image sensors, energy-storage components e.g. battery, a communication facility, a global positioning system “GPS” a receiver, a laser line projector, a differential imaging camera, and, potentially, other types of sensors. Data obtained from one or more sensors 1308, some of which are identified above, can be utilized to determine the orientation, location, and movement of the computing device 1300. As discussed above, data obtained from a differential imaging camera and a laser line projector, or other types of sensors, can also be utilized to generate a 3D depth map of the surrounding real-world environment 111.

In the illustrated example, the computing device 1300 includes one or more logic devices and one or more computer memory devices storing instructions executable by the logic devices to implement the functionality disclosed herein. In particular, a controller 1318 can include one or more processing units 1320, one or more computer-readable media 1322 for storing an operating system 1324, an image-generation engine 1326 and a terrain-mapping engine 1328, and other programs such as a 3D depth map generation module configured to generate depth map data 1329 “mesh data” in the manner disclosed herein, and other data. The depth map data 1329 can define a model of the physical object 110 and the physical environment 111. For instance, the depth map data 1329 can define coordinates of the physical object 110 within the physical environment 111. In addition, parameters of the physical environment can be defined in the depth map data, such as boundaries, obstacles, and other objects within the physical environment.

In some implementations, the computing device 1300 is configured to analyze data obtained by the sensors 1308 to perform feature-based tracking of an orientation of the computing device 1300. For example, in a scenario in which the object data includes an indication of a stationary physical object 110 within the real-world environment 111 e.g., a bicycle, the computing device 1300 might monitor a position of the stationary object within a terrain-mapping field-of-view “FOV”. Then, based on changes in the position of the stationary object within the terrain-mapping FOV and a depth of the stationary object from the computing device 1300, a terrain-mapping engine executing on the processing units 1320 the AR might calculate changes in the orientation of the computing device 1300.

It can be appreciated that these feature-based tracking techniques might be used to monitor changes in the orientation of the computing device 1300 for the purpose of monitoring an orientation of a user's head e.g., under the presumption that the computing device 1300 is being properly worn by a user 104. The computed orientation of the computing device 1300 can be utilized in various ways, some of which have been described above.

The processing units 1320, can represent, for example, a central processing unit “CPU”-type processor, a graphics processing unit “GPU”-type processing unit, an FPGA, one or more digital signal processors “DSPs”, or other hardware logic components that might, in some instances, be driven by a CPU. For example, and without limitation, illustrative types of hardware logic components that can be used include ASICs, Application-Specific Standard Products “ASSPs”, System-on-a-Chip Systems “SOCs”, Complex Programmable Logic Devices “CPLDs”, etc. The controller 1318 can also include one or more computer-readable media 1322, such as the computer-readable media described above.

It is to be appreciated that conditional language used herein such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

It should also be appreciated that many variations and modifications may be made to the above-described examples, the elements of which are to be understood as being among other acceptable examples. All such modifications and variations are intended to be included herein within the scope of this disclosure and protected by the following claims.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

### Example Clauses

The disclosure presented herein may be considered in view of the following clauses.

Example clause A, a computing device, comprising: one or more data processing units; and a computer-readable medium having encoded thereon computer-executable instructions to cause the one or more data processing units to: cause a display of a user interface on a display device comprising renderings of a plurality of objects; receive input data from a sensor, the input data defining a gaze gesture performed by a user; determine a gaze target within the user interface based on a direction of the gaze gesture; select an object from the plurality of objects in response to determining that the gaze target meets one or more criteria with the object; determine an object type of the object based on a format of data defining the object; select a set of functions specific to performing a modification of at least one attribute of the data defining the object; provide a notification indicating the object type and the set of functions; and receive a subsequent input from the user indicating a selection of a function of the set of functions, the selection causing execution of the function for modifying the at least one attribute of the object.

Example clause B, the system of Example clause A, wherein the instructions further cause the one or more data processing units to: receive sensor data generated by a sensor, the sensor data comprising image data of a physical object and depth map data defining a model of the physical object positioned within a physical environment, wherein the physical object is one of the plurality of objects rendered in the user interface and selected by the gaze gesture, and wherein the set of functions are specific to modifying an attribute of the physical object.

Example clause C, the system of Example clauses A through B, wherein the set of functions comprises at least one of computer-executable instructions for modifying a display property of the sensor data to increase the prominence of the rendering of the physical object on the user interface, or computer-executable instructions for modifying permissions enabling one or more users to modify a display property of the physical object, wherein the permissions enable one or more users to adjust a zoom level, adjust a brightness level of the rendering of the physical object, or adjust a contrast level of the rendering of the physical object.

Example clause D, the system of Example clauses A through C, wherein the instructions further cause the one or more data processing units to: receive model data defining a three-dimensional model of a virtual object, the model data defining dimensions and textures of the virtual object, wherein the virtual object is one of the plurality of objects rendered in the user interface and selected by the gaze gesture, and wherein the set of functions are specific to modifying an attribute of the virtual object.

Example clause E, the system of Example clauses A through D, wherein the set of functions comprises at least one of computer-executable instructions for modifying a display property of the model data to increase the prominence of the rendering of the virtual object on the user interface, or computer-executable instructions for modifying permissions enabling one or more users to modify a display property of the virtual object, wherein the permissions enable one or more users to resize, rotate, or change textures of the virtual object.

Example clause F, the system of Example clauses A through E, wherein the instructions further cause the one or more data processing units to: receive content data, the content data defining a content object, wherein the content object is one of the plurality of objects rendered in the user interface and selected by the gaze gesture, and wherein the set of functions are specific to modifying an attribute of the content object.

Example clause G, the system of Example clauses A through F, wherein the set of functions comprises at least one of computer-executable instructions for modifying the content data, computer-executable instructions for modifying a display property of the content data to increase the prominence of the rendering of the content object on the user interface, or computer-executable instructions for modifying permissions enabling one or more users to modify the content data.

Example clause H, the system of Example clauses A through G, wherein determining that the gaze target meets one or more criteria with the object in response to determining that the gaze target remains within a location having a threshold amount of overlap with the rendering of the object for a predetermined time period.

Example clause I, the system of Example clauses A through H, wherein determining that the gaze target meets one or more criteria with the object in response to: determining that the gaze target remains within a location having a threshold amount of overlap with the rendering of the object for a predetermined time period; and receiving a voice input confirming the selection of the object within the gaze target.

Example clause J, the system of Example clauses A through I, wherein determining that the gaze target meets one or more criteria with the object in response to determining that the gaze target remains within a predetermined distance from a predetermined point in the rendering of the object for a predetermined time period.

Example clause K, the system of Example clauses A through J, wherein a method for execution to be performed by a data processing system, the method comprising: causing a display of a user interface on a display device comprising renderings of a plurality of objects; receive input data from an input device, the input data defining a gaze gesture performed by a user; determine a gaze target within the user interface based on a direction of the gaze gesture; select an object from the plurality of objects in response to determining that the gaze target meets one or more criteria with the object; in response selecting the object when the gaze target meets one or more criteria with the object, modify at least one display attribute of the rendering of the object to bring focus to the object.

Example clause L, the system of Example clauses A through K, wherein modifying at least one display attribute of the rendering of the object comprises at least one of increasing a size of the rendering of the object or moving the rendering to a centralized location within the user interface.

Example clause M, the system of Example clauses A through L, wherein the method further comprises reducing a size of the rendering of at least one other object of the plurality of objects.

Example clause N, the system of Example clauses A through M, wherein the method further comprises moving the rendering of at least one other object of the plurality of objects towards the perimeter of the user interface.

Example clause O, the system of Example clauses A through N, wherein modifying at least one display attribute of the rendering of the object comprises: determining a crop region within the rendering of the object; and increase a scale of the rendering of the object to zoom into the crop region.

Example clause P, the system of Example clauses A through O, further comprising receiving a supplemental input defining a direction, wherein modifying at least one display attribute of the rendering of the object further comprises: determining a position for the rendering of the object based on the direction indicated in the gesture; and rendering the object at the position.

Example clause Q, A method for execution to be performed by a data processing system, the method comprising: causing a display of a user interface on a display device comprising renderings of a plurality of objects; receive input data from an input device, the input data defining a gaze gesture performed by a user; determine a gaze target within the user interface based on a direction of the gaze gesture; select an object from the plurality of objects in response to determining that the gaze target meets one or more criteria with the object; in response selecting the object when the gaze target meets one or more criteria with the object, modify at least one display attribute of the rendering of the object to bring focus to the object.

Example clause R, the method of Example clause Q, wherein modifying at least one display attribute of the rendering of the object comprises at least one of increasing a size of the rendering of the object or moving the rendering to a centralized location within the user interface.

Example clause S, the method of Example clauses Q through R, wherein the method further comprises reducing the size of the rendering of at least one other object of the plurality of objects.

Example clause T, the method of Example clauses Q through S, wherein the method further comprises moving the rendering of at least one other object of the plurality of objects towards the perimeter of the user interface.

Example clause U, the method of Example clauses Q through T, wherein modifying at least one display attribute of the rendering of the object comprises: determining a crop region within the rendering of the object; and increase a scale of the rendering of the object to zoom into the crop region.

Example clause V, the method of Example clauses Q through U, further comprising receiving a supplemental input defining a direction, wherein modifying at least one display attribute of the rendering of the object further comprises: determining a position for the rendering of the object based on the direction indicated in the gesture; and rendering the object at the position.

Example clause W, A system, comprising: means for receiving communication data defining a plurality of objects for display on a user interface; means for causing a display of the user interface on a display device comprising renderings of the plurality of objects; means for receiving input data from a sensor, the input data defining a gaze gesture performed by a user; means for determining a gaze target within the user interface based on a direction of the gaze gesture; means for selecting an object from the plurality of objects in response to determining that the gaze target meets one or more criteria with the object; means for determining an object type of the object based on a format of input data defining the object; means for selecting a set of functions specific to performing a modification of at least one attribute of the input data defining the object, wherein the set of functions are selected based on the object type; means for providing a notification indicating the object type and the set of functions; and means for receiving a subsequent input from the user indicating a selection of a function of the set of functions, the selection causing execution of the function for modifying the at least one attribute of the object,

Example clause X, the system of clause W wherein the instructions further cause the one or more data processing units to: receive sensor data generated by a sensor, the sensor data comprising image data of a physical object and depth map data defining a model of the physical object positioned within a physical environment, wherein the physical object is one of the plurality of objects rendered in the user interface and selected by the gaze gesture, and wherein the set of functions are specific to modifying an attribute of the physical object, wherein the set of functions comprises at least one of computer-executable instructions for modifying a display property of the sensor data to increase the prominence of the rendering of the physical object on the user interface, or computer-executable instructions for modifying permissions enabling one or more users to modify a display property of the physical object, wherein the permissions enable one or more users to adjust a zoom level, adjust a brightness level of the rendering of the physical object, or a contrast level of the rendering of the physical object.

Example clause Y, the system of clauses W through X, wherein the instructions further cause the one or more data processing units to: receive model data defining a three-dimensional model of a virtual object, the model data defining dimensions and textures of the virtual object, wherein the virtual object is one of the plurality of objects rendered in the user interface and selected by the gaze gesture, and wherein the set of functions are specific to modifying an attribute of the virtual object, wherein the set of functions comprises at least one of computer-executable instructions for modifying a display property of the model data to increase the prominence of the rendering of the virtual object on the user interface, or computer-executable instructions for modifying permissions enabling one or more users to modify a display property of the virtual object, wherein the permissions enable one or more users to resize, rotate, or change textures of the virtual object.

Example clause Z, the system of clauses W through Y, wherein the instructions further cause the one or more data processing units to: receive content data, the content data defining a content object, wherein the content object is one of the plurality of objects rendered in the user interface and selected by the gaze gesture, and wherein the set of functions comprises at least one of computer-executable instructions for modifying the content data, computer-executable instructions for modifying a display property of the content data to increase the prominence of the rendering of the content object on the user interface, or computer-executable instructions for modifying permissions enabling one or more users to modify the content data.

1. A computing device, comprising:
one or more data processing units; and
a computer-readable medium having encoded thereon computer-executable instructions to cause the one or more data processing units to:
cause a display of a user interface on a display device comprising renderings of a plurality of objects;
receive input data from a sensor, the input data defining a gaze gesture performed by a user;
determine a gaze target within the user interface based on a direction of the gaze gesture;
select an object from the plurality of objects in response to determining that the gaze target meets one or more criteria with the object;
determine an object type of the object based on a format of data defining the object;
select a set of functions specific to performing a modification of at least one attribute of the data defining the object;
provide an interaction control indicating the object type and the set of functions; and
receive a subsequent input from the user indicating a selection of a function of the set of functions, the selection causing execution of the function for modifying the at least one attribute of the object.

2. The system of claim 1, wherein the instructions further cause the one or more data processing units to:
receive sensor data generated by a sensor, the sensor data comprising image data of a physical object and depth map data defining a model of the physical object positioned within a physical environment, wherein
the physical object is one of the plurality of objects rendered in the user interface and selected by the gaze gesture, and wherein
the set of functions are specific to modifying an attribute of the physical object.

3. The system of claim 2, wherein the set of functions comprises at least one of computer-executable instructions for modifying a display property of the sensor data to increase the prominence of the rendering of the physical object on the user interface, or computer-executable instructions for modifying permissions enabling one or more users to modify a display property of the physical object, wherein the permissions enable one or more users to adjust a zoom level, adjust a brightness level of the rendering of the physical object, or adjust a contrast level of the rendering of the physical object.

4. The system of claim 1, wherein the instructions further cause the one or more data processing units to: receive model data defining a three-dimensional model of a virtual object, the model data defining dimensions and textures of the virtual object, wherein the virtual object is one of the plurality of objects rendered in the user interface and selected by the gaze gesture, and wherein the set of functions are specific to modifying an attribute of the virtual object.

5. The system of claim 4, wherein the set of functions comprises at least one of computer-executable instructions for modifying a display property of the model data to increase the prominence of the rendering of the virtual object on the user interface, or computer-executable instructions for modifying permissions enabling one or more users to modify a display property of the virtual object, wherein the permissions enable one or more users to resize, rotate, or change textures of the virtual object.

6. The system of claim 1, wherein the instructions further cause the one or more data processing units to:
receive content data, the content data defining a content object, wherein the content object is one of the plurality of objects rendered in the user interface and selected by the gaze gesture, and wherein the set of functions are specific to modifying an attribute of the content object, wherein the set of functions comprises at least one of computer-executable instructions for modifying the content data, computer-executable instructions for modifying a display property of the content data to increase the prominence of the rendering of the content object on the user interface, or computer-executable instructions for modifying permissions enabling one or more users to modify the content data.

7. The system of claim 1, wherein the instructions further cause the one or more data processing units to receive content data, the content data defining a content object and a link to a virtual object, wherein the virtual object is one of the plurality of objects rendered in the user interface and selected by the gaze gesture, and wherein the set of functions are specific to modifying an attribute of the virtual object.

8. The system of claim 1, wherein determining that the gaze target meets one or more criteria with the object in response to determining that the gaze target remains within a location having a threshold amount of overlap with the rendering of the object for a predetermined time period.

9. The system of claim 1, wherein determining that the gaze target meets one or more criteria with the object in response to:
determining that the gaze target remains within a location having a threshold amount of overlap with the rendering of the object for a predetermined time period; and
receiving a voice input confirming the selection of the object within the gaze target.

10. The system of claim 1, wherein determining that the gaze target meets one or more criteria with the object in response to determining that the gaze target remains within a predetermined distance from a predetermined point in the rendering of the object for a predetermined time period.

11. A method for execution to be performed by a data processing system, the method comprising:
causing a display of a user interface on a display device comprising renderings of a plurality of objects;
receive input data from an input device, the input data defining a gaze gesture performed by a user;
determine a gaze target within the user interface based on a direction of the gaze gesture;
select an object from the plurality of objects in response to determining that the gaze target meets one or more criteria with the object;
in response selecting the object when the gaze target meets one or more criteria with the object, modify at least one display attribute of the rendering of the object to bring focus to the object, wherein the modified attribute is applied to a user interface for at least one remote computing device associated with a user having a predetermined role or a predetermined access permission.

12. The method of claim 11, wherein modifying at least one display attribute of the rendering of the object comprises at least one of increasing a size of the rendering of the object or moving the rendering to a centralized location within the user interface.

13. The method of claim 11, wherein the method further comprises reducing a size of the rendering of at least one other object of the plurality of objects.

14. The method of claim 11, wherein the predetermined access permission includes a permission to access a file that is shared during a communication session between the remote computing device and the processing system.

15. The method of claim 11, wherein modifying at least one display attribute of the rendering of the object comprises:
determining a crop region within the rendering of the object; and
increase a scale of the rendering of the object to zoom into the crop region.

16. The method of claim 11, further comprising receiving a supplemental input defining a direction, wherein modifying at least one display attribute of the rendering of the object further comprises:
determining a position for the rendering of the object based on the direction indicated in the gesture; and
rendering the object at the position.

17. A system, comprising:
means for receiving communication data defining a plurality of objects for display on a user interface;
means for causing a display of the user interface on a display device comprising renderings of the plurality of objects;
means for receiving input data from a sensor, the input data defining a gaze gesture performed by a user;
means for determining a gaze target within the user interface based on a direction of the gaze gesture;
means for selecting an object from the plurality of objects in response to determining that the gaze target meets one or more criteria with the object;
means for determining an object type of the object based on a format of input data defining the object;
means for selecting a set of functions specific to performing a modification of at least one attribute of the input data defining the object, wherein the set of functions are selected based on the object type or a state of at least one function of the set of functions;
means for providing a notification indicating the object type and the set of functions; and
means for receiving a subsequent input from the user indicating a selection of a function of the set of functions, the selection causing execution of the function for modifying the at least one attribute of the object.

18. The system of claim 17, wherein the instructions further cause the one or more data processing units to:
receive sensor data generated by a sensor, the sensor data comprising image data of a physical object and depth map data defining a model of the physical object positioned within a physical environment, wherein
the physical object is one of the plurality of objects rendered in the user interface and selected by the gaze gesture, and wherein
the set of functions are specific to modifying an attribute of the physical object, wherein the set of functions comprises at least one of computer-executable instructions for modifying a display property of the sensor data to increase the prominence of the rendering of the physical object on the user interface, or computer-executable instructions for modifying permissions enabling one or more users to modify a display property of the physical object, wherein the permissions enable one or more users to adjust a zoom level, adjust a brightness level of the rendering of the physical object, or a contrast level of the rendering of the physical object.

19. The system of claim 17, wherein the instructions further cause the one or more data processing units to: receive model data defining a three-dimensional model of a virtual object, the model data defining dimensions and textures of the virtual object, wherein the virtual object is one of the plurality of objects rendered in the user interface and selected by the gaze gesture, and wherein the set of functions are specific to modifying an attribute of the virtual object, wherein the set of functions comprises at least one of computer-executable instructions for modifying a display property of the model data to increase the prominence of the rendering of the virtual object on the user interface, or computer-executable instructions for modifying permissions enabling one or more users to modify a display property of the virtual object, wherein the permissions enable one or more users to resize, rotate, or change textures of the virtual object.

20. The system of claim 17, wherein the instructions further cause the one or more data processing units to: receive content data, the content data defining a content object, wherein the content object is one of the plurality of objects rendered in the user interface and selected by the gaze gesture, and wherein the set of functions comprises at least one of computer-executable instructions for modifying the content data, computer-executable instructions for modifying a display property of the content data to increase the prominence of the rendering of the content object on the user interface, or computer-executable instructions for modifying permissions enabling one or more users to modify the content data.
